(19) United States
(12) Patent Application Publication
(10) Pub. No.: US 2019/0106354 A1
(43) Pub. Date: Apr. 11, 2019

(54) ANTIMICROBIAL MATERIALS INCLUDING EXCHANGED AND INFUSED ANTIMICROBIAL AGENTS

(71) Applicant: CORNING INCORPORATED, Corning, NY (US)

(72) Inventors: Arthur Winston Martin, Madison, AL (US); Carlton Truesdale, Corning, NY (US); Florence Christine Monique Verrier, Corning, NY (US)

(73) Assignee: CORNING INCORPORATED, Corning, NY (US)

(21) Appl. No.: 15/506,044

(22) PCT Filed: Aug. 28, 2015
(86) PCT No.: PCT/US15/47373

§ 371 Date: Feb. 23, 2017

Related U.S. Application Data
(60) Provisional application No. 62/043,547, filed on Aug. 29, 2014.
(60) Provisional application No. 62/052,698, filed on Sep. 19, 2014.

(51) Int. Cl. C03C 21/00; A01N 59/16; A01N 25/14

(52) U.S. Cl. CPC C03C 21/005; C03C 3/097; A01N 25/14; A01N 59/16

(57) ABSTRACT

Embodiments of antimicrobial materials are provided. In one or more embodiments, the antimicrobial materials include an inorganic substrate including a surface portion surrounding an internal portion and an antimicrobial agent disposed on any one or more of the surface portion and the internal portion. In some embodiments, the inorganic substrate included alkali and at least a portion of the alkali is present on the surface portion. In another embodiment the antimicrobial agent is infused into the substrate. In some instances, non-alkali components present in the substrate are replaced with the antimicrobial agent. In some embodiments, anions in the substrate are replaced with the antimicrobial agent. Compositions including the antimicrobial materials are disclosed and methods for making the antimicrobial materials and compositions are also provided.

### CROSS-REFERENCE TO RELATED APPLICATIONS

This application is a national stage entry of International Patent Application Serial No. PCT/US15/47373 filed on Aug. 28, 2015, which claims the benefit of priority under 35 U.S.C. § 119 of U.S. Provisional Application Ser. No. 62/052,698 filed on Sep. 19, 2014 and U.S. Provisional Application Ser. No. 62/043,547 filed on Aug. 29, 2014, the content of which is relied upon and incorporated herein by reference in its entirety.

### BACKGROUND

The disclosure relates to antimicrobial materials including antimicrobial agents that are exchanged and infused into a substrate, compositions that include such antimicrobial materials and methods for making the same.

Known alkali-containing materials often utilize established ion-exchange techniques to exchange various agents (including antimicrobial agents) into substrates. In some instances, this exchange process can impart color to the substrate, produce substrates with different refractive indices, and generate a compressive stress layer or antimicrobial agent-containing region in the substrate. Existing antimicrobial materials utilize silver ion technologies which are costly to manufacture and do not exhibit a controlled release mechanism. In some instances, these materials contain fully soluble silver ions and a fully soluble polymer in a mixture of water and/or ethanol, micron-sized zeolite carriers that are encapsulated into the durable soft, polyurethane surfaces of fabrics, or coatings including silver ions. Such materials are limited by their alkali content and the restrictions of known ion exchange processes.

Accordingly, there is a need for antimicrobial materials that are not restricted by the alkali content of the substrates utilized and include tunable concentrations of antimicrobial agents, which are controllably released and are released to the exclusion of all other leachables. Methods of forming such materials in a timely and cost-effective manner are also desirable.

### SUMMARY

A first aspect of this disclosure pertains to an antimicrobial material including an inorganic substrate including a surface portion surrounding an internal portion and an antimicrobial agent disposed on any one or more of the surface portion and the internal portion. The antimicrobial agent may be exchanged and infused into the substrate.

In one or more embodiments, the substrate includes alkali and at least a portion of the alkali is present on the surface portion, even where the antimicrobial agent is disposed on any one or more of the surface portion and the internal portion.

In one or more embodiments, the antimicrobial material includes an infused antimicrobial agent disposed on any one or more of the surface portion and the internal portion. In such embodiments, the substrate may include non-alkali components which are exchanged with the antimicrobial agent. The substrate may be optionally substantially free of alkali components or substantially alkali-free.

In one or more embodiments, the substrate includes anions (e.g., oxygen) and at least at portion of the anions is exchanged for the antimicrobial agent. In one or more embodiments, the antimicrobial material includes any one or more of Si—OH, H₂O and H₃O⁺ at a depth of about 1 micrometer or greater into the substrate.

The antimicrobial material of one or more embodiments includes leachables that include only the antimicrobial agent (i.e., there are no other leachables). In some instances, the leachables are released in the presence of moisture. In some examples, the leachables are released at a rate of about 0.1 parts per million (ppm) or less. In other examples, the leachables are released at a rate from about 0.03 ppm to about 7 ppm. In further examples, the leachables are released at a rate from about 5 ppm to about 80 ppm. Such leach rates may be exhibited when the antimicrobial material is combined in or otherwise exposed to an aqueous solution.

The antimicrobial agent may be present in the antimicrobial material in an amount in the range from about 1% by weight to about 40% by weight. The concentration of the antimicrobial agent may be homogenous.

The inorganic substrate may be a sheet or a particle and/or may be amorphous or crystalline. In some examples, the inorganic substrate may include a particle having an average longest cross-sectional dimension in the range from about 1 nanometer (nm) to about 10 millimeter (mm) (e.g., from about 1 nanometer (nm) to about 1000 nanometers (nm), from about 1 micrometers (μm) to about 1000 micrometers (μm), or from about 1 millimeter (mm) to about 10 millimeter (mm)). In certain implementations, the inorganic substrate may include particles having an average longest cross-sectional dimension of about 0.3 μm, 0.4 μm, 0.5 μm, 0.6 μm, 0.7 μm, 0.8 μm, 0.9 μm, 1 μm, 2 μm, 3 μm, 4 μm, and up to 5 μm. In the foregoing aspects, the particle may have a regular geometry or an irregular geometry.

The antimicrobial material of one or more embodiments exhibits a 5 log reduction or greater in a concentration of Escherichia coli, when the antimicrobial material is present in an aqueous solution having an antimicrobial material concentration of about 0.007 g/liter or greater and the aqueous solution is exposed to Escherichia coli in water at 23° C. after 90 minutes. In other embodiments, the antimicrobial material exhibits a 5 log reduction or greater in a concentration of Escherichia coli, when the antimicrobial agent is combined with an aqueous solution having an antimicrobial material concentration of about 0.07 g/liter or greater and the aqueous solution is exposed to Escherichia coli in water at 23° C. after 1 minute.

The antimicrobial material of one or more embodiments may comprise a portion of a cosmetic, oral care product, a personal care product, a clothing care product, a home care product, auto care products, touch-sensitive display screen or cover plate for an electronic device, a non-touch-sensitive component of an electronic device, a surface of a household appliance, a surface of medical equipment, a biological or medical packaging vessel, or a surface of a vehicle component.

A second aspect of this disclosure pertains to a composition including a carrier and the antimicrobial materials described herein. The carrier can include a surfactant, a polymer or a combination thereof. The composition may exhibit a 5 log reduction or greater in a concentration of Escherichia coli, when the composition is exposed to Escherichia coli in water at 23° C. after 90 minutes. The composition may include cosmetics, oral care products, personal care products, clothing care products, or home care products.

A third aspect of this disclosure pertains to a method of forming an antimicrobial material, which includes providing an inorganic substrate (as described herein) and exchanging and infusing an antimicrobial agent into the inorganic substrate at a pressure of about 5 MPa or greater to provide an antimicrobial material. The method may include combining the antimicrobial material with a carrier, such as a surfactant, a polymer or a combination thereof.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1A is an illustration of an antimicrobial material in sheet form of one or more embodiments;

FIG. 1B is an illustration of an antimicrobial material in particulate form of one or more embodiments;

FIGS. 2A-2F are illustration of antimicrobial materials of one or more embodiments;

FIG. 3 is a schematic of a bath and pressure vessel employed in a system for exchanging and infusing an antimicrobial agent into an inorganic substrate, according to one embodiment;

FIG. 4 is a schematic of the system depicted in FIG. 2 with substrates immersed in the bath and vessel according to another embodiment;

FIGS. 5a-5j show photographs of the Nutrient Agar plates including Escherichia coli and particles according to Example 1 and a control material;

FIG. 6 is a graph showing inactivation of Escherichia coli as a function of time when contacted with the antimicrobial material of Example 1;

FIG. 7 show images obtained with high-angle annular dark-field imaging (HAADF) showing the presence of the antimicrobial agents as nanoparticles on the surface of the antimicrobial material;

FIG. 8 is a graph showing the log reduction of Escherichia coli of Examples 3A-3C at various dilutions;

FIG. 9 is a graph showing the log reduction of Escherichia coli of Example 3C before and after reducing re-oxidizing, at various dilutions;

FIG. 10 is a graph showing the antimicrobial activity of Example 3C and Comparative Examples 3D-3F when combined with a paint (with no surfactant) and when combined with a paint and surfactant;

FIG. 11 is a graph showing a Secondary Ion Mass Spectrometry (SIMS) spectra of Examples 4A and 4B;

FIG. 12 is a Fourier Transform Infrared (FTIR) spectra of Example 4A, Comparative Example 4C and Example 4D;

FIG. 13 is a graph showing the concentration of silver ions leached from particles of Example 5, measured daily;

FIG. 14 is a graph showing the accumulated concentration of silver ions leached from particles of Example 5 as a function of time;

FIG. 15 is a chart showing the concentration of silver ions leached from particles of Example 7; and

FIG. 16 is a graph showing the cross-sectional dimensions of the particles of Example 1.

### DETAILED DESCRIPTION

Reference will now be made in detail to various embodiment(s) and examples, some of which are illustrated in the accompanying drawings.

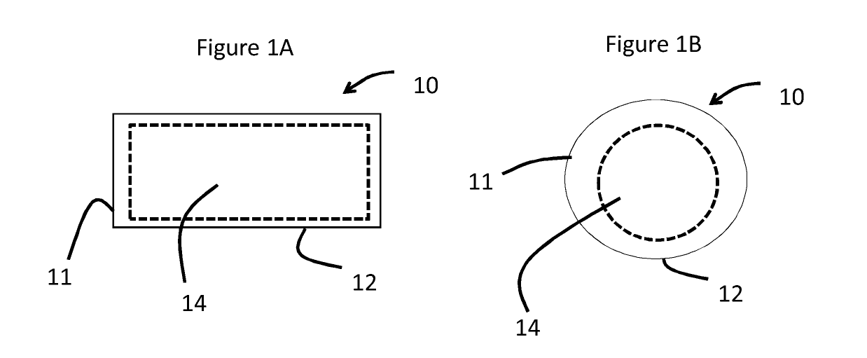

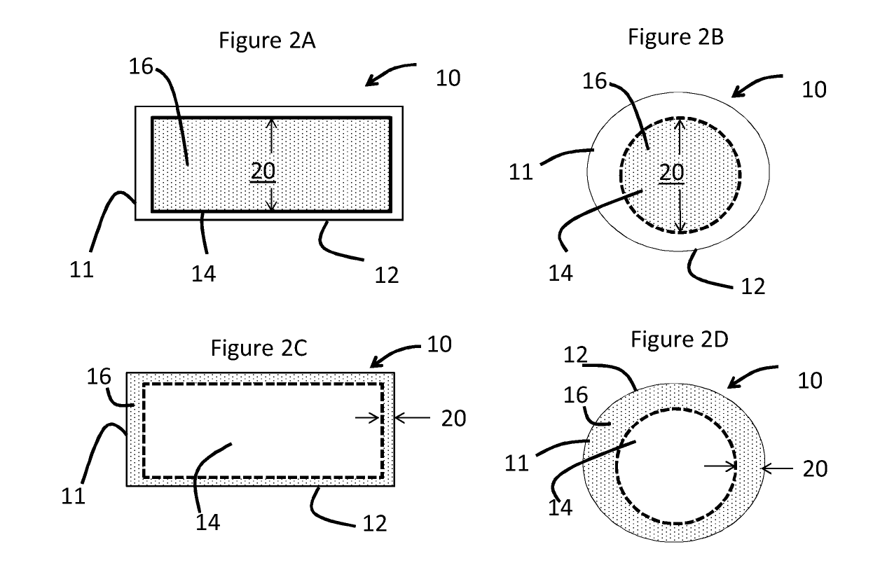

A first aspect of this disclosure pertains to an antimicrobial material 10 including a substrate 11 and an antimicrobial agent. As will be described herein and shown in FIGS. 1A and 1B, the substrate 11 includes a surface portion 12 surrounding an internal portion 14. The antimicrobial agent may be present on a surface portion 12 of the substrate, in an internal portion 14 of the substrate or both the surface portion 12 and an internal portion 14 of the substrate. The antimicrobial agent may be present as an exchanged and infused component, as will be described herein, and can be used in combination with a variety of substrates at a variety of concentration levels.

The substrate may be characterized as inorganic and either alkali-containing or alkali-free. In one or more embodiments, the substrate may include various glasses, glass-ceramics, ceramics, and the like. The shape of the substrate is not limited and can include particulate substrates (as shown in FIG. 1B), sheet-like substrates (as shown in FIG. 1A) or three-dimensionally shaped substrates.

Where the particulate substrates are utilized, the particles may include an average longest cross-sectional dimension in the range from about 1 nanometer (nm) to about 10 millimeters (mm). As used herein, the term “longest cross-sectional dimension” refers to the longest single dimension of a given item (e.g., particle, pore, or the like). Thus, to clarify, when an item is circular, the longest cross-sectional dimension is its diameter; when an item is oval-shaped, the longest cross-sectional dimension is the longest diameter of the oval; and when an item is irregularly-shaped, the longest cross-sectional dimension is the line between the two farthest opposing points on its perimeter. In some instances, the particles may include an average longest cross-sectional dimension in the range from about 1 nanometers (nm) to about 1000 nanometers (nm), from about 1 micrometers (μm) to about 1000 micrometers (μm), and from about 1 millimeter (mm) to about 10 millimeter (mm). In certain aspects, the inorganic substrate may include particles having an average longest cross-sectional dimension of about 0.3 μm, 0.4 μm, 0.5 μm, 0.6 μm, 0.7 μm, 0.8 μm, 0.9 μm, 1 μm, 2 μm, 3 μm, 4 μm, and up to 5 μm. The particulate inorganic substrates may have a regular geometry or an irregular geometry. The geometry may be characterized as any one or more of spherical, trapezoidal, square, rectangular, triangular, cylindrical, rhombohedrum, rhombic dodecahedron, rhombic tria-contrahedron, and rhombic enneacontrahedron.

The substrates having a sheet-like shape may exhibit a physical thickness ranging from about 100 μm to about 5 mm. Example substrate physical thicknesses range from about 100 μm to about 500 μm (e.g., 100, 200, 300, 400 or 500 μm). Further example substrate physical thicknesses range from about 500 μm to about 1000 μm (e.g., 500, 600, 700, 800, 900 or 1000 μm). The substrate may have a physical thickness greater than about 1 mm (e.g., about 2, 3, 4, or 5 mm). In one or more specific embodiments, the substrate may have a physical thickness of 2 mm or less or less than 1 mm. Additionally or alternatively, where sheet-like substrates are utilized, the physical thickness of the substrate may vary along one or more of its dimensions for aesthetic and/or functional reasons. For example, the edges of the substrate may be thicker as compared to more central regions of the substrate. The length, width and physical thickness dimensions of the substrate may also vary according to the application or use of the antimicrobial material 10. The sheets may be shaped in three-dimensional forms and/or may be characterized as rigid or flexible.

Regardless of the shape of the substrate, the substrate may also be acid polished or otherwise treated to remove or reduce the effect of surface flaws.

In one or more embodiments, the substrate may be characterized as insoluble in reactive environments. As used herein with respect to the substrate, “reactive environments” includes environments in which the silica bonds in the substrate can or are degraded. An example of such reactive environments includes contact between the substrate and a material having a pH of about 10 or greater or a pH or about 2 or less.

Substrate may be inorganic, and may include alkali or be alkali-free. In one or more embodiments, the substrate may be amorphous and may include glass, which may be strengthened or non-strengthened. Examples of suitable glass include soda lime glass, alkali-free glass, alkali aluminosilicate glass, alkali containing borosilicate glass and alkali aluminoborosilicate glass. In some variants, the glass may be free of alkali and, in particular, may be free of any one or more of lithia, sodium, potassium, rubidium, and cessium. In one or more alternative embodiments, the substrate may include crystalline substrates such as glass ceramic substrates (which may be strengthened or non-strengthened) or may include a single crystal structure, such as sapphire. Examples of suitable glass ceramic substrates include substrates with beta-spodumene (including both Li and Cu types, and solid solutions of Li, Cu, Mg, and Na), beta-quartz (including beta-eucryptite and virgilite), nepheline, carnegieite, pollucite, leucite (K[AlSi₂O₆), trisilicic fluormicas (including phlogopite and biotite), tetrasilicic fluormicas (including taeniolite and polylithionite), alkali-bearing cordierite and osumilite, canasite, agrellite and fluoramphiboles. In one or more specific embodiments, the substrate includes an amorphous base (e.g., glass) and a crystalline cladding (e.g., sapphire layer, a polycrystalline alumina layer and/or or a spinel (MgAl₂O₄) layer). In some embodiments, the substrate may be silica-containing or silica-free (e.g., substantially free of silica). The substrate may be characterized as oxidizable or non-oxidizable.

The substrate may be substantially optically clear, transparent and free from light scattering. In such embodiments, the substrate may exhibit an average transmittance over the optical wavelength regime of about 85% or greater, about 86% or greater, about 87% or greater, about 88% or greater, about 89% or greater, about 90% or greater, about 91% or greater or about 92% or greater. In one or more alternative embodiments, the substrate 110 may be opaque or exhibit an average transmittance over the optical wavelength regime of less than about 10%, less than about 9%, less than about 8%, less than about 7%, less than about 6%, less than about 5%, less than about 4%, less than about 3%, less than about 2%, less than about 1%, or less than about 0%. In one or more embodiments, the substrate may optionally exhibit a color, such as white, black, red, blue, green, yellow, orange etc. In one or more embodiments, the substrate may exhibits a refractive index in the range from about 1.45 to about 1.55.

The substrate may be provided using a variety of different processes. For instance, where the substrate includes an amorphous substrate such as glass, various forming methods can include float glass processes and down-draw processes such as fusion draw and slot draw. Where particulates are utilized, the substrate may further be formed into particulates using jet milling, ball milling, attrition milling, air and inert gas milling and/or other known techniques known in the art.

Once formed, a substrate may be strengthened to form a strengthened substrate. The strengthening process may occur before, after or simultaneously with the exchange and infusion of the antimicrobial agent into the substrate. As used herein, the term “strengthened substrate” may refer to a substrate that has been chemically strengthened, for example through ion-exchange of larger ions for smaller ions in the surface portion 12 of the substrate. However, other strengthening methods known in the art, such as thermal tempering, or utilizing a mismatch of the coefficient of thermal expansion between portions of the substrate to create compressive stress and central tension regions, may be utilized to form strengthened substrates.

Where the substrate is chemically strengthened by an ion exchange process, the ions in the substrate from the surface portion 12 to a depth into the substrate are replaced by—or exchanged with—larger ions having the same valence or oxidation state. Ion exchange processes are typically carried out by immersing a substrate in a molten salt bath containing the larger ions to be exchanged with the smaller ions in the substrate. It will be appreciated by those skilled in the art that parameters for the ion exchange process, including, but not limited to, bath composition and temperature, immersion time, the number of immersions of the substrate in a salt bath (or baths), use of multiple salt baths, additional steps such as annealing, washing, and the like, are generally determined by the composition of the substrate and the desired compressive stress (CS), depth of compressive stress layer (or depth of layer) of the substrate that result from the strengthening operation. By way of example, ion exchange of alkali metal-containing glass substrates may be achieved by immersion in at least one molten bath containing a salt such as, but not limited to, nitrates, sulfates, and chlorides of the larger alkali metal ion. The temperature of the molten salt bath typically is in a range from about 380° C. up to about 450° C., while immersion times range from about 15 minutes up to about 40 hours. However, temperatures and immersion times different from those described above may also be used.

In addition, non-limiting examples of ion exchange processes in which glass substrates are immersed in multiple ion exchange baths, with washing and/or annealing steps between immersions, are described in U.S. patent application Ser. No. 12/500,650, filed Jul. 10, 2009, by Douglas C. Allan et al., entitled “Glass with Compressive Surface for Consumer Applications” and claiming priority from U.S. Provisional Patent Application No. 61/079,995, filed Jul. 11, 2008, in which glass substrates are strengthened by immersion in multiple, successive, ion exchange treatments in salt baths of different concentrations; and U.S. Pat. No. 8,312,739, by Christopher M. Lee et al., issued on Nov. 20, 2012, entitled “Dual Stage Ion Exchange for Chemical Strengthening of Glass,” and claiming priority from U.S. Provisional Patent Application No. 61/084,398, filed Jul. 29, 2008, in which glass substrates are strengthened by ion exchange in a first bath diluted with an effluent ion, followed by immersion in a second bath having a smaller concentration of the effluent ion than the first bath. The contents of U.S. patent application Ser. No. 12/500,650 and U.S. Pat. No. 8,312,739 are incorporated herein by reference in their entirety.

The degree of chemical strengthening achieved by ion exchange may be quantified based on the parameters of central tension (CT), surface CS, and depth of layer (DOL). Surface CS may be measured near the surface or within the strengthened glass at various depths. A maximum CS value may include the measured CS at the surface (CSₛ) of the strengthened substrate. The CT, which is computed for the inner region adjacent the compressive stress layer within a glass substrate, can be calculated from the CS, the physical thickness t, and the DOL. CS and DOL are measured using those means known in the art. Such means include, but are not limited to, measurement of surface stress (FSM) using commercially available instruments such as the FSM-6000, manufactured by Luceo Co., Ltd. (Tokyo, Japan), or the like, and methods of measuring CS and DOL are described in ASTM 1422C-99, entitled “Standard Specification for Chemically Strengthened Flat Glass,” and ASTM 1279.19779 “Standard Test Method for Non-Destructive Photoelastic Measurement of Edge and Surface Stresses in Annealed, Heat-Strengthened, and Fully-Tempered Flat Glass,” the contents of which are incorporated herein by reference in their entirety. Surface stress measurements rely upon the accurate measurement of the stress optical coefficient (SOC), which is related to the birefringence of the glass substrate. SOC in turn is measured by those methods that are known in the art, such as fiber and four point bend methods, both of which are described in ASTM standard C770-98 (2008), entitled “Standard Test Method for Measurement of Glass Stress-Optical Coefficient,” the contents of which are incorporated herein by reference in their entirety, and a bulk cylinder method. The relationship between CS and CT is given by the expression (1):

CT=(CS·DOL)/(t−2DOL) (1),

wherein t is the physical thickness (μm) of the substrate. In various sections of the disclosure, CT and CS are expressed herein in megaPascals (MPa), physical thickness t is expressed in either micrometers (μm) or millimeters (mm) and DOL is expressed in micrometers (μm).

In one embodiment, a strengthened substrate can have a surface CS of 250 MPa or greater, 300 MPa or greater, e.g., 400 MPa or greater, 450 MPa or greater, 500 MPa or greater, 550 MPa or greater, 600 MPa or greater, 650 MPa or greater, 700 MPa or greater, 750 MPa or greater or 800 MPa or greater. The strengthened substrate may have a DOL of 10 μm or greater, 15 μm or greater, 20 μm or greater (e.g., 25 μm, 30 μm, 35 μm, 40 μm, 45 μm, 50 μm or greater) and/or a CT of 10 MPa or greater, 20 MPa or greater, 30 MPa or greater, 40 MPa or greater (e.g., 42 MPa, 45 MPa, or 50 MPa or greater) but less than 100 MPa (e.g., 95, 90, 85, 80, 75, 70, 65, 60, 55 MPa or less). In one or more specific embodiments, the strengthened substrate has one or more of the following: a surface CS greater than 500 MPa, a DOL greater than 15 μm, and a CT greater than 18 MPa.

Example glasses that may be used in the substrate may include alkali aluminosilicate glass compositions or alkali aluminoborosilicate glass compositions, though other glass compositions are contemplated. Such glass compositions are capable of being chemically strengthened by an ion exchange process. One example glass composition comprises SiO₂, B₂O₃ and Na₂O, where (SiO₂+B₂O₃)≥66 mol. %, and Na₂O≥9 mol. %. In an embodiment, the glass composition includes at least 6 wt. % aluminum oxide. In a further embodiment, the substrate includes a glass composition with one or more alkaline earth oxides, such that a content of alkaline earth oxides is at least 5 wt. %. Suitable glass compositions, in some embodiments, further comprise at least one of K₂O, MgO, and CaO. In a particular embodiment, the glass compositions used in the substrate can comprise 61-75 mol. % SiO₂; 7-15 mol. % Al₂O₃; 0-12 mol. % B₂O₃; 9-21 mol. % Na₂O; 0-4 mol. % K₂O; 0-7 mol. % MgO; and 0-3 mol. % CaO.

A further example glass composition suitable for the substrate comprises: 60-70 mol. % SiO₂; 6-14 mol. % Al₂O₃; 0-15 mol. % B₂O₃; 0-15 mol. % Li₂O; 0-20 mol. % Na₂O; 0-10 mol. % K₂O; 0-8 mol. % MgO; 0-10 mol. % CaO; 0-5 mol. % ZrO₂; 0-1 mol. % SnO₂; 0-1 mol. % CeO₂; less than 50 ppm As₂O₃; and less than 50 ppm Sb₂O₃; where 12 mol. %≤(Li₂O+Na₂O+K₂O)≤20 mol. % and 0 mol. %≤(MgO+CaO)≤10 mol. %.

A still further example glass composition suitable for the substrate comprises: 63.5-66.5 mol. % SiO₂; 8-12 mol. % Al₂O₃; 0-3 mol. % B₂O₃; 0-5 mol. % Li₂O; 8-18 mol. % Na₂O; 0-5 mol. % K₂O; 1-7 mol. % MgO; 0-2.5 mol. % CaO; 0-3 mol. % ZrO₂; 0.05-0.25 mol. % SnO₂; 0.05-0.5 mol. % CeO₂; less than 50 ppm As₂O₃; and less than 50 ppm Sb₂O₃; where 14 mol. %≤(Li₂O+Na₂O+K₂O)≤18 mol. % and 2 mol. %≤(MgO+CaO)≤7 mol. %.

In a particular embodiment, an alkali aluminosilicate glass composition suitable for the substrate comprises alumina, at least one alkali metal and, in some embodiments, greater than 50 mol. % SiO₂, in other embodiments at least 58 mol. % SiO₂, and in still other embodiments at least 60 mol. % SiO₂, wherein the ratio

$$\frac{{Al}_{2} {O}_{3} + {B}_{2} {O}_{3}}{{\sum }^{ } modifiers} > 1 ,$$

where in the ratio the components are expressed in mol. % and the modifiers are alkali metal oxides. This glass composition, in particular embodiments, comprises: 58-72 mol. % SiO₂; 9-17 mol. % Al₂O₃; 2-12 mol. % B₂O₃; 8-16 mol. % Na₂O; and 0-4 mol. % K₂O, wherein the ratio

$$\frac{{Al}_{2} {O}_{3} + {B}_{2} {O}_{3}}{{\sum }^{ } modifiers} > 1.$$

In still another embodiment, the substrate may include an alkali aluminosilicate glass composition comprising: 64-68 mol. % SiO₂; 12-16 mol. % Na₂O; 8-12 mol. % Al₂O₃; 0-3 mol. % B₂O₃; 2-5 mol. % K₂O; 4-6 mol. % MgO; and 0-5 mol. % CaO, wherein: 66 mol. %≤SiO₂+B₂O₃+CaO≤69 mol. %; Na₂O+K₂O+B₂O₃+MgO+CaO+SrO>10 mol. %; 5 mol. %≤MgO+CaO+SrO≤8 mol. %; (Na₂O+B₂O₃)≤Al₂O₃ 2 mol. %; 2 mol. %≤Na₂O−Al₂O₃≤6 mol. %; and 4 mol. %≤(Na₂O+K₂O)≤Al₂O₃10 mol. %.

In an alternative embodiment, the substrate may comprise an alkali aluminosilicate glass composition comprising: 2 mol % or more of Al₂O₃ and/or ZrO₂, or 4 mol % or more of Al₂O₃ and/or ZrO₂.

In some embodiments, the substrate includes a ratio of SiO₂ to Al₂O₃ of about 14:1 or in the range from about 13:1 to about 15:1.

Where the substrate 11 includes a crystalline substrate, the substrate may include a single crystal, which may include Al₂O₃. Such single crystal substrates are referred to as sapphire. Other suitable crystalline materials include polycrystalline alumina layer and/or spinel (MgAl₂O₄).

Optionally, the crystalline substrate may include a glass ceramic substrate, which may be strengthened or non-strengthened. Examples of suitable glass ceramics may include Li₂O—Al₂O₃—SiO₂ system (i.e. LAS-System) glass ceramics, MgO—Al₂O₃—SiO₂ system (i.e. MAS-System) glass ceramics, and/or glass ceramics that include a predominant crystal phase including β-quartz solid solution, β-spodumene ss, cordierite, and lithium disilicate. The glass ceramic substrates may be strengthened using the chemical strengthening processes disclosed herein. In one or more embodiments, MAS-System glass ceramic substrates may be strengthened in Li₂SO₄ molten salt, whereby an exchange of 2Li⁺ for Mg²⁺ can occur.

In specific embodiments, the substrate may exhibit an average strain-to-failure at a surface on one or more opposing major surface that is 0.5% or greater, 0.6% or greater, 0.7% or greater, 0.8% or greater, 0.9% or greater, 1% or greater, 1.1% or greater, 1.2% or greater, 1.3% or greater, 1.4% or greater 1.5% or greater or even 2% or greater, as measured using ball-on-ring testing using at least 5, at least 10, at least 15, or at least 20 samples. In specific embodiments, the substrate 11 may exhibit an average strain-to-failure at its surface on one or more opposing major surface of about 1.2%, about 1.4%, about 1.6%, about 1.8%, about 2.2%, about 2.4%, about 2.6%, about 2.8%, or about 3% or greater.

Suitable substrates 11 may exhibit an elastic modulus (or Young's modulus) in the range from about 30 GPa to about 120 GPa. In some instances, the elastic modulus of the substrate may be in the range from about 30 GPa to about 110 GPa, from about 30 GPa to about 100 GPa, from about 30 GPa to about 90 GPa, from about 30 GPa to about 80 GPa, from about 30 GPa to about 70 GPa, from about 40 GPa to about 120 GPa, from about 50 GPa to about 120 GPa, from about 60 GPa to about 120 GPa, from about 70 GPa to about 120 GPa, and all ranges and sub-ranges therebetween.

The antimicrobial agents that may be utilized include any one or more of various heavy metal ions (e.g., Ag, Cu, Zn, Au ions). For example, the antimicrobial agents may include a combination of any one or more of Ag, Cu, Zn and Au. In one or more embodiments, the antimicrobial agent may be exchanged and infused onto the surface portion 12 of the substrate 11 and/or into an internal portion 14 of the substrate 11.

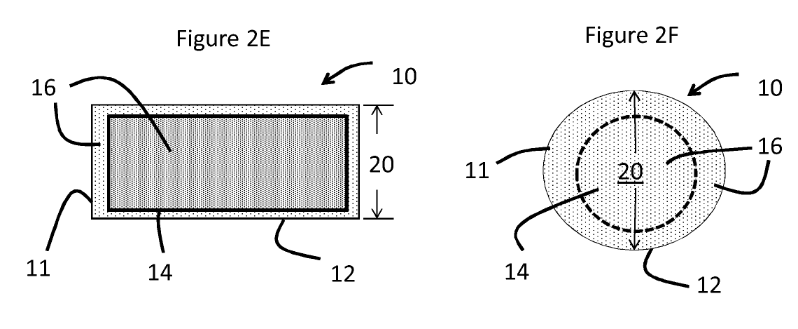

In one or more embodiments, the antimicrobial agent 16 (which is shown as stippled area in FIGS. 2A-2F) is present in only the surface portion 12, only in an internal portion 14 or in both the surface portion 12 and the internal portion 14. In some embodiments, the area(s) in which the antimicrobial agent 16 is present may be characterized as a depth of region (DOR) including the antimicrobial agent. As shown in FIGS. 2A and 2B, the antimicrobial agent 16 is present in only an internal portion 14 and includes a DOR 20. In FIGS. 2C and 2D, the antimicrobial agent 16 is present in only the surface portion 12 and has a DOR 20. In FIGS. 2E and 2F, the antimicrobial agent 16 is present in both the internal portion 14 and the surface portion 12. As shown in FIG. 2E, the concentration of the antimicrobial agent 16 may vary from the internal portion 14 to the surface portion 12 or may be homogenous in the internal portion 14 and the surface portion, as shown in FIG. 2F.

In one or more embodiments, the DOR at least partially overlaps with the compressive stress layer of the substrate. In some embodiments, the depth of the compressive stress layer (DOL) is greater than the DOR. In other embodiments, the DOL and the DOR are about the same. The DOR may be generally limited so as to avoid visible coloration in the antimicrobial material and to maximize the antimicrobial efficacy of the antimicrobial agent within the substrate.

In one or more embodiments, the DOR may have an average thickness of less than about 100 micrometers (μm), less than about 50 micrometers (μm) or less than about 20 micrometers (μm). For example, the average thickness may be in the range from about 0.01 micrometers (μm) to about 50 micrometers (μm), from about 0.01 micrometers (μm) to about 30 micrometers (μm), from about 0.01 micrometers (μm) to about 25 micrometers (μm), from about 0.01 micrometers (μm) to about 20 micrometers (μm), from about 0.01 micrometers (μm) to about 18 micrometers (μm), from about 0.01 micrometers (μm) to about 16 micrometers (μm), from about 0.01 micrometers (μm) to about 14 micrometers (μm), from about 0.01 micrometers (μm) to about 12 micrometers (μm), from about 0.01 micrometers (μm) to about 10 micrometers (μm), from about 0.01 micrometers (μm) to about 8 micrometers (μm), from about 0.01 micrometers (μm) to about 6 micrometers (μm), from about 0.01 micrometers (μm) to about 5 micrometers (μm), from about 0.01 micrometers (μm) to about 4 micrometers (μm), from about 0.1 micrometers (μm) to about 20 micrometers (μm), from about 0.5 micrometers (μm) to about 20 micrometers (μm), from about 1 micrometer (μm) to about 20 micrometers (μm), from about 2 micrometers (μm) to about 20 micrometers (μm), from about 5 micrometers (μm) to about 20 micrometers (μm), or from about 10 micrometers (μm) to about 20 micrometers (μm), and all ranges and sub-ranges therebetween.

In one or more embodiments, the antimicrobial agent may be present in an amount in the range from about 1 weight percent (wt %) to about 40 wt % of the antimicrobial material. In one some embodiments, the antimicrobial agent may be present in the antimicrobial material in an amount in the range from about 1 wt % to about 38 wt %, from about 1 wt % to about 36 wt %, from about 1 wt % to about 34 wt %, from about 1 wt % to about 32 wt %, from about 1 wt % to about 30 wt %, from about 1 wt % to about 28 wt %, from about 1 wt % to about 26 wt %, from about 1 wt % to about 24 wt %, from about 1 wt % to about 22 wt %, from about 1 wt % to about 20 wt %, from about 2 wt % to about 40 wt %, from about 3 wt % to about 40 wt %, from about 4 wt % to about 40 wt %, from about 5 wt % to about 40 wt %, from about 6 wt % to about 40 wt %, from about 7 wt % to about 40 wt %, from about 8 wt % to about 40 wt %, from about 9 wt % to about 40 wt %, from about 10 wt % to about 40 wt %, from about 12 wt % to about 40 wt %, from about 14 wt % to about 40 wt %, from about 16 wt % to about 40 wt %, from about 18 wt % to about 40 wt %, from about 20 wt % to about 40 wt %, from about 1 wt % to about 10 wt %, from about 1 wt % to about 8 wt %, from about 1 wt % to about 6 wt %, or from about 1 wt % to about 5 wt %, and all ranges and sub-ranges therebetween. In some embodiments, the foregoing concentration of the antimicrobial agent may be determined in terms of a concentration of the oxide form of the antimicrobial agent (e.g., Ag₂O, Cu₂O, CuO, ZnO, and Au₂O).

The concentration of the antimicrobial agent may be defined within a specific thickness of the DOR. For example, the concentration of the antimicrobial agent within an outermost or innermost 50 nanometers (nm) of the DOR is up to about 45 wt %, based on a total weight of this outermost or innermost 50 nanometers (nm) of the DOR. In some embodiments, the concentration of the antimicrobial agent within this outermost or innermost 50 nanometers of the DOR is up to about 10 wt %, or up to about 6 wt %.

The exchange and infusion of the antimicrobial agent results in an antimicrobial material with a unique composition, which may be described in terms of the alkali components and the non-alkali components present in the substrate before and after the exchange and infusion of the antimicrobial agent.

As used herein, the term “exchange” refers to the introduction of first cations into the surface portion 12 (and potentially the internal portion 14) of the substrate 11 and replacement of other cations having the same valence/charge/oxidation state as the first cations or the replacement of other cations having a different valence/charge/oxidation state as the first cations. In one or more embodiments, the other cations that are replaced (or exchanged) out of the substrate include alkali components in the substrate. In one or more embodiments, the other cations that are replaced out of the substrate are non-alkali components of the substrate. As used herein, the term “infused” refers to the introduction of first cations into the surface portion 12 (and potentially the internal portion 14) of the substrate by a physical process in which the first cations are introduced into interstitial space(s). The first cations are released from the substrate in specific environments.

The first cations (as used with the term “exchange” and/or “infused”) may include more than one type of cations (e.g., any one or more of Ag⁺, Na⁺ and K⁺ etc.), and may include larger cations that the other cations in the substrate. Exchange is referenced above with regard to chemically strengthening the substrate; however, it should be noted that the process for exchanging the antimicrobial agent into the substrate described herein utilizes a method that differs in terms of pressure, temperature and other such parameters than the chemical strengthening process. An example of this differing method is described in U.S. Provisional Patent Application No. 61/977,692, filed on Apr. 10, 2014, which is described in more detail below and is incorporated herein by reference in its entirety.

In one or more embodiments, the antimicrobial agent is present on the surface portion of the substrate and/or in an internal portion of the substrate such that the substrate 11 includes some alkali components on the surface portion 12. In one or more specific embodiments, the amount of the antimicrobial agent present in the antimicrobial material (in the surface portion and/or the internal portion) is greater than the amount of alkali components present in the substrate, prior to the exchange and infusion of the antimicrobial agent. The presence of a greater amount of antimicrobial agent in the antimicrobial material than the original amount of the alkali components in the substrate indicates the infusion of the antimicrobial agent into the substrate.

In one or more embodiments, the antimicrobial material includes a substrate that is substantially free of alkali components. As used herein, the phrases “substantially free of alkali components” or “substantially alkali-free” are interchangeable and mean the substrate includes less than about 0.1 wt % alkali or less than about 0.01 wt % alkali. In one or more embodiments that utilize a substrate that is substantially free of alkali components, the antimicrobial agent is exchanged into the substrate (i.e., on the surface portion, in the internal portion or a combination thereof). In such embodiments, the exchanged antimicrobial agent replaces one or more non-alkali components in the substrate.

In one or more embodiments, the antimicrobial material includes a substrate that includes anions and the antimicrobial agent replaces at least a portion of the anions in the substrate. In some embodiments, the anions replaced by the antimicrobial agent may include oxygen.

In some embodiments, the antimicrobial material includes any one or more of Si—OH, H₂O and H₃O⁺, which may be present at depths of about 100 nanometers (nm) or greater into the substrate, where the depth is measured from the surface portion 12. In some embodiments, the any one or more of Si—OH, H₂O and H₃O⁺ may be present at depths of about 500 nanometers (nm) or greater, about 1 micrometer (μm) or greater, about 2 micrometers (μm) or greater, about 3 micrometers (μm) or greater, about 4 micrometers (μm) or greater, about 5 micrometers (μm) or greater, about 10 micrometers (μm) or greater, about 15 micrometers (μm) or greater, about 20 micrometers (μm) or greater, about 25 micrometers (μm) or greater, about 30 micrometers (μm) or greater, or in the range from about 500 nanometers (nm) to about 30 micrometers (μm). In some instances, the any one or more of Si—OH, H₂O and H₃O⁺ may be present at all depths of the substrate. In such embodiments, the antimicrobial agent may be characterized as being exchanged and infused into the entire thickness of the substrate. In one or more embodiments, the Si—OH present in the antimicrobial material is formed from hydronium (H₃O+) ions entrapped in the substrate. Such ions may be present when the antimicrobial material is formed at low temperature (e.g., about 200° C. or less). In some embodiments, a portion of the Si—OH forms H2O.

In one or more embodiments, the antimicrobial material includes leachables (or components that leach out of the substrate). In one or more embodiments, such leachables consist essentially of the antimicrobial agent.

In some embodiments, the antimicrobial agent includes a silver-containing agent that exhibits a specific leachability of silver ions. In other words, the antimicrobial material may exhibit a specific leachability of such silver ions. To determine leachability, the antimicrobial material was suspended in 1 ml of water at different concentration (e.g., in the range from about 70 mg/ml to about 7 μg/ml) for 2 minutes. The antimicrobial material in solution was then filtered through a 0.5 μm membrane filter. Amount of leached silver ions (or other antimicrobial agent) in solution was measured immediately by inductively coupled plasma mass spectrometry (ICP-MS). The following leachability rate may be exhibited in water and other test media. For example, the leachability of silver ions from the antimicrobial agent, as measured when the antimicrobial agent is present in a solution with water at a concentration of about 0.007 g/l or greater (e.g., 70 g/l), may be less than about 0.1 parts per million (ppm). This leachability rate of less than about 0.1 parts per million (ppm) may be exhibited for a period of time greater than about 1 hour, greater than 1 day, or greater than 7 days. In other embodiments, the leachability of silver ions from the antimicrobial agent, as measured when the antimicrobial agent is present in a solution with water at a concentration of about 0.007 g/l or greater (e.g., 70 g/l), may be in the range from about 0.03 parts per million (ppm) to about 7 parts per million (ppm), which may be exhibited for a period of time greater than about 1 hour, greater than 1 day, or greater than 7 days. In some instances, such leachability may be exhibited for 100 days or more, or even 200 days or more. In some instances, the leachability of the silver ions may be in the range from about 0.03 parts per million (ppm) to about 6.5 parts per million (ppm), from about 0.03 parts per million (ppm) to about 6 parts per million (ppm), from about 0.03 parts per million (ppm) to about 5.5 parts per million (ppm), from about 0.03 parts per million (ppm) to about 5 parts per million (ppm), from about 0.03 parts per million (ppm) to about 4.5 parts per million (ppm), from about 0.03 parts per million (ppm) to about 4 parts per million (ppm), from about 0.03 parts per million (ppm) to about 3.5 parts per million (ppm), from about 0.03 parts per million (ppm) to about 3 parts per million (ppm), from about 0.03 parts per million (ppm) to about 2.5 parts per million (ppm), from about 0.03 parts per million (ppm) to about 2 parts per million (ppm), from about 0.05 parts per million (ppm) to about 5 parts per million (ppm), from about 0.1 parts per million (ppm) to about 5 parts per million (ppm), from about 0.5 parts per million (ppm) to about 5 parts per million (ppm), from about 1 part per million (ppm) to about 5 parts per million (ppm), from about 1.5 parts per million (ppm) to about 5 parts per million (ppm), from about 2 parts per million (ppm) to about 5 parts per million (ppm), or from about 3 parts per million (ppm) to about 5 parts per million (ppm), and all ranges and sub-ranges therebetween. In further implementations, the leachability of silver ions from the antimicrobial agent may be in the range from about 5 ppm to about 80 ppm, and all ranges and sub-ranges therebetween.

The controlled release of the antimicrobial agent from the antimicrobial material of one or more embodiments can be compared to known zeolite-based or organic-based (or polymer-based) antimicrobial materials. Known zeolite-based or polymer-based antimicrobial materials have an open structure and thus, release the antimicrobial agents contained therein rapidly and may also release other undesirable leachables (i.e., leachables other than the antimicrobial agents). The structure of the antimicrobial materials of one or more embodiments of this disclosure may be characterized as a glassy, amorphous structure. In comparison, known zeolites-based antimicrobial materials have a ceramic, crystalline structure with long range crystalline order with pore sizes in the range from about 4 Å to about 15 Å. The closed structure of one or more embodiments of the antimicrobial material of this disclosure permits release of antimicrobial agents only at the surface, and antimicrobial agents contained in internal portions diffuse or move from the internal portion to the surface for release. This provides controlled and long term release of the antimicrobial agents, rather than the rapid release permitted by the open structure of known zeolite-based materials. Moreover, the release of only the antimicrobial agents as leachables can be distinguished from known organic-based or polymer-based antimicrobial materials, which can release other undesirable leachables.

In some embodiments, the antimicrobial material exhibits this increased antimicrobial activity despite having a significantly smaller surface area (as compared to known zeolite-based antimicrobial materials). For example, in some embodiments, the antimicrobial material may be provided in small particulate form and exhibits a surface area of about 0.5 m²/g or less. In contrast, the surface area for known zeolite-based antimicrobial materials have a surface area of about 150 m²/g or greater.

The antimicrobial material described herein exhibits antimicrobial efficacy against various microbes (e.g., bacteria, viruses and fungi). The antimicrobial efficacy that will be described herein is also exhibited by the combination of the antimicrobial material with a carrier, as described herein.

In one or more embodiments, the antimicrobial material exhibits a 2 log reduction or greater (e.g., about 2.5 log reduction or greater, about 3 log reduction or greater, about 3.5 log reduction or greater, about 4 log reduction or greater, about 5 log reduction or greater or about 5.5 log reduction or greater) in any one or more of the following bacteria: Staphylococcus aureus, Enterobacter aerogenes, Pseudomonas aeruginosa, Methicillin Resistant Staphylococcus aureus, and Escherichia coli.

In one or more specific embodiments, the antimicrobial material exhibits a 5 log reduction or greater in a concentration of Escherichia coli, when the antimicrobial material is present in an aqueous solution having an antimicrobial material concentration of about 0.007 g/liter or greater and the aqueous solution is exposed to Escherichia coli in water at 23° C. after 90 minutes. In one or more embodiments, the antimicrobial material exhibits a 5 log reduction or greater in a concentration of Escherichia coli, when the antimicrobial agent is combined with an aqueous solution having an antimicrobial material concentration of about 0.07 g/liter or greater and the aqueous solution is exposed to Escherichia coli in water at 23° C. after 1 minute.

The antimicrobial material of one or more embodiments exhibits such log reductions of bacteria under JIS Z 2801 (2000) testing conditions or under a Modified JIS Z 2801 (2000) Test for bacteria, wherein the modified conditions of JIS Z 2801 (2000) comprise heating the antimicrobial material to a temperature of about 23 degrees Celsius to about 37 degrees Celsius at a humidity of about 38 percent to about 42 percent for about 24 hours followed by drying for about 6 hours to about 24 hours. In one or more embodiments these log reductions of bacteria are exhibited under a Dry Test. The Dry Test is described in U.S. Provisional Patent Application No. 61/908,401, which is hereby incorporated by reference in its entirety as if fully set forth below. Under the Dry Test, an inoculum was prepared as follows: inoculating nutrient agar with a portion of a stock having a plurality of bacterial organisms to form a culture, incubating the culture to form a first incubated culture, incubating a portion of the first incubated culture with nutrient agar to form a second incubated culture, incubating a portion of the second incubated culture with nutrient agar to form a third incubated culture, incubating the third incubated culture for approximately 48 hours to form an inoculated test plate with a plurality of bacterial colonies, and suspending a portion of the plurality of bacterial colonies in a buffered test solution of Minimum Essential Medium solution with 15% Fetal Bovine Serum (FBS), adjusting the test solution to a pH of approximately 7 to 8, and adding an organic soil serum at a concentration of approximately 10% to 30% by weight to the test solution. Each of the samples was inoculated with the inoculum and incubated for about 2 hours. Each sample was then washed in a neutralizing solution to form a residual test inoculum. The number of surviving bacterial colonies per volume in the residual test inoculum was then counted to calculate the percent reduction in the number of surviving bacterial colonies in the residual test inoculum (relative to a control residual inoculum).

In some instances, the antimicrobial material exhibits a 2 log reduction or greater in at least one of Staphylococcus aureus, Enterobacter aerogenes, Pseudomonas aeruginosa bacteria, Methicillin Resistant Staphylococcus aureus, and Escherichia coli, under the EPA Test Method for Efficacy of Copper Alloy as a Sanitizer testing conditions (the “EPA Test”). In some embodiments, such antimicrobial material includes a copper-containing antimicrobial agent.

In one or more embodiments, the antimicrobial material exhibits a 0.5 log reduction or greater (e.g., 1 log reduction or greater, or a 2 log reduction or greater) in a concentration of any one or more of Influenza viruses, Human Immunodeficiency Virus, and Murine Norovirus, under modified JIS Z 2801 (2000) testing conditions for evaluating viruses (hereinafter, “Modified JIS Z 2801 for Viruses”).

The Modified JIS Z 2801 Test for Viruses includes the following procedure. For each material (e.g., the antimicrobial material and any comparative materials) to be tested, three samples of the material (contained in individual sterile petri dishes) are each inoculated with a 20 μL aliquot of a test virus (where antimicrobial activity is measured) or a test medium including an organic soil load of 5% fetal bovine serum with or without the test virus (where cytotoxicity is measured). The inoculum is then covered with a film and the film is pressed down so the test virus and/or or test medium spreads over the film, but does not spread past the edge of the film. The exposure time begins when each sample was inoculated. The inoculated samples are transferred to a control chamber set to room temperature (about 20° C.) in a relative humidity of 42% for 2 hours. Exposure time with respect to control samples are discussed below. Following the 2-hour exposure time, the film is lifted off using sterile forceps and a 2.00 mL aliquot of the text virus and/or test medium is pipetted individually onto each sample of material and the underside of the film (or the side of the film exposed to the sample) used to cover each sample. The surface of each sample is individually scrapped with a sterile plastic cell scraper to collect the test virus or test medium. The test virus and/or test medium is collected (at 10⁻² dilution), mixed using a vortex type mixer and serial 10-fold dilutions are prepared. The dilutions are then assayed for antimicrobial activity and/or cytotoxicity.

To prepare a control sample for testing antimicrobial activity (which are also referred to as “zero-time virus controls”) for the Modified JIS Z 2801 Test for Viruses, three control samples (contained in individual sterile petri dishes) are each inoculated with a 20 μL aliquot of the test virus. Immediately following inoculation, a 2.00 mL aliquot of test virus is pipetted onto each control sample. The surface of each sample was individually scrapped with a sterile plastic cell scraper to collect test virus. The test virus is collected (at 10⁻² dilution), mixed using a vortex type mixer, and serial 10-fold dilutions were prepared. The dilutions are assayed for antimicrobial activity.

To prepare controls samples for cytotoxicity (which are also referred to as “2 hour control virus”) for the Modified JIS Z 2801 Test for Viruses, one control sample (contained in an individual sterile petri dish) is inoculated with a 20 μL aliquot of a test medium containing an organic soil load (5% fetal bovine serum), without the test virus. The inoculum is covered with a film and the film is pressed so the test medium spreads over the film but does not spread past the edge of the film. The exposure time begins when each control sample is inoculated. The control sample is transferred to a controlled chamber set to room temperature (20° C.) in a relative humidity of 42% for a duration of 2 hours exposure time. Following this exposure time, the film is lifted off using sterile forceps and a 2.00 mL aliquot of the test medium is pipetted individually onto each control sample and the underside of the film (the side exposed to the sample). The surface of each sample is individually scrapped with a sterile plastic cell scraper to collect the test medium. The test medium is collected (at 10⁻² dilution), mixed using a vortex type mixer, and serial 10-fold dilutions were prepared. The dilutions were assayed for cytotoxicity.

In some embodiments, the antimicrobial material may exhibit the log reductions described herein (i.e., under the EPA Test, the JIS Z 2801 testing conditions, the Modified JIS Z 2801 Test for Bacteria and/or the Modified JIS Z 2801 Test for Viruses), for a period of one month or greater or for a period of three months or greater. The one month period or three month period may commence at or after the formation of the antimicrobial material, or at or after combination of the antimicrobial material with a carrier, as will be described herein.

In some embodiments, the antimicrobial material may exhibit the log reductions described herein (i.e., under the EPA Test, the JIS Z 2801 testing conditions, the Modified JIS Z 2801 Test for Bacteria and/or the Modified JIS Z 2801 Test for Viruses), after exposure to high temperatures (e.g., about 180° C. or greater). In contrast, known zeolite-based antimicrobial materials do not exhibit such activity at high temperatures. In addition, these log reductions are exhibited by embodiments of the antimicrobial material even in acidic or highly alkaline conditions (e.g., pH in the range from about 2 to about 10). In contrast, known zeolite-based antimicrobial materials do not exhibit such activity an acidic or highly alkaline conditions.

The embodiments of the antimicrobial materials described herein may comprise at least a portion of cosmetic product (e.g., foundation, powder, blush, eye liner, facial cream, eye cream and the like), oral care product (e.g., toothpaste, dental floss, mouthwash, whitening strips, and toothbrushes), a personal care products (deodorant, shampoo, conditioner, hand soap, facial soap, body soap, after shave, and shaving cream), a clothing care product (e.g., detergent, fabric softeners, and dryer sheets), or a home care product (e.g., household cleaners, sponges, towels, dish soap, and dishwasher detergent).

In some instances, the various embodiments of the antimicrobial material may comprise at least a portion of a touch-sensitive display screen or cover plate for an electronic device, a non-touch-sensitive component of an electronic device, a surface of a household appliance, a surface of medical equipment, a biological or medical packaging vessel, or a surface of a vehicle component.

In some instances, the antimicrobial material may comprise at least a portion of paints (e.g., for use in residences, hospitals, laboratories or schools), coatings for packaging (e.g., food and medicine packaging), textiles, sporting equipment, orthodontic devices (e.g., dentures, bracers, filling, pallet expanders), wound care (e.g., bandages), anti-microbial sprays and biomedical devices (e.g., catheters, IV needles, orthopedics devices, surgical mask and other medical devices). In one or more embodiments, the antimicrobial material may be used for water purification, waste water treatment and for air purification.

One or more embodiments, the antimicrobial material may exhibit a preservative function. In such embodiments, the antimicrobial material may kill or eliminate, or reduce the growth of various foulants such as fungi, bacteria, viruses and combinations thereof that are often present in carriers, such as paints, varnishes, polymers etc.

A second aspect of this disclosure pertains to compositions including the antimicrobial materials described herein. In one or more embodiments, the composition may include a carrier, and the antimicrobial materials described herein. The carrier may include materials suitable for combining the antimicrobial material in a solution and may include a surfactant, solvent, a polymer or a combination thereof. In other embodiments, the carrier may include materials suitable for combining the antimicrobial material into injection moldable materials, extrudable materials or materials suitable for coatings or drawing into fibers. Examples of suitable surfactants include dioctyl sulfosuccinate sodium salt (available from also known as, AOT, Bis(2-ethylhexyl) sulfosuccinate sodium salt, DOSS, and docusate sodium), N-Lauroylsarcosine sodium salt (also known as N-Dodecanoyl-N-methylglycine sodium salt, and Sarkosyl NL), Sodium dodecyl sulfate (also known as dodecyl sodium sulfate, dodecyl sulfate sodium salt, lauryl sulfate sodium salt, SDS, and sodium lauryl sulfate), Sodium taurodeoxycholate hydrate (also known as 2-([3α,12α-Dihydroxy-24-oxo-5β-cholan-24-yl]amino)ethanesulfonic acid, and taurodeoxycholic acid sodium salt hydrate), sodium citrate tribasic dehydrate, sodium dodecanoate (also known as dodecanoic acid sodium salt, lauric acid sodium salt, and sodium laurate), sodium bistridecyl sulfosuccinate, sodium dioctyl sulfosuccinate, diester sulfosuccinates and blends thereof (such as those available from Cytec Industries, including sodium dihexyl sulfosuccinate, sodium dicyclohexyl sulfosucciate, sodium diamyl sulfosuccinate, and sodium diisobutyl sulfosuccinate), alkylamine-guanidine polyoxyethanol, mono-ester sulfosuccinates (including disodium ethoxylated alcohol half ester of sulfosuccinic acid, disodium ethoxylated nonyl phenol half ester of sulfosuccinic acid), sulfoscuccinamates (including disodium N-octadecyl sulfosuccinamate, tetra sodium N-(1,2 dicarboxy ethyl)-N-octadecyl sulfosuccinamate and tetra sodium N-(1,2 dicarboxy ethyl)-N-octadec(en)yl sulfosuccinamate) and nonyl phenol ether sulfates (including ammonium salt of sulfated nonylphenoxy poly (ethyleneoxy) ethanol), and alkyl naphthalene sulfonates (including sodium diisopropyle naphthalene sulfonate).

In some embodiments, a combination of surfactants may be utilized. In some embodiments, the surfactant may include a specific amount or minimum amount of sodium cations, which may exchange with the antimicrobial agent so that the antimicrobial agent is present or readily available at the surface of the antimicrobial materials. In some embodiments, the surfactants include specific anions which can facilitate dispersion of the antimicrobial material in carriers such as polymers.

In some embodiments, stabilizer may be utilized such as stabilizers that are charge stabilized, amine stabilized (e.g., polethyleneimine), steric stabilized (e.g., NIPAM), carboxylic acids (e.g., dextran, polyalginic acid, poly(acrylic acid), and maltose), and poly(vinylpyrrolidone).

Examples of suitable polymers include, without limitation: thermoplastics including polystyrene (PS), high impact PS, polycarbonate (PC), nylon (sometimes referred to as polyamide (PA)), poly(acrylonitrile-butadiene-styrene) (ABS), PC-ABS blends, polybutyleneterephthlate (PBT) and PBT co-polymers, polyethyleneterephthalate (PET) and PET co-polymers, polyolefins (PO) including polyethylenes (PE), polypropylenes (PP), cyclicpolyolefins (cyclic-PO), modified polyphenylene oxide (mPPO), polyvinylchloride (PVC), acrylic polymers including polymethyl methacrylate (PMMA), thermoplastic elastomers (TPE), thermoplastic urethanes (TPU), polyetherimide (PEI) and blends of these polymers with each other. Suitable injection moldable thermosetting polymers include epoxy, acrylic, styrenic, phenolic, melamine, urethanes, polyesters and silicone resins. In other embodiments, the polymers may be dissolved in a solvent or dispersed as a separate phase in a solvent, such as a latex, that is, a water emulsion of a synthetic or natural rubber or plastic obtained by polymerization and used especially in coatings (as paint) and adhesives. The polymers can contain impact modifiers, flame retardants, UV inhibitors, antistatic agents, mold release agents, fillers including glass, metal or carbon fibers or particles (including spheres), talc, clay or mica and colorants.

The compositions described herein exhibit the same or greater level of efficacy as the antimicrobial materials described herein against bacteria, viruses and fungi. For example, the composition may exhibit a 2 log reduction or greater (e.g., about 2.5 log reduction or greater, about 3 log reduction or greater, about 3.5 log reduction or greater, about 4 log reduction or greater, about 5 log reduction or greater or about 5.5 log reduction or greater) in any one or more of the following bacteria: Staphylococcus aureus, Enterobacter aerogenes, Pseudomonas aeruginosa, Methicillin Resistant Staphylococcus aureus, and Escherichia coli. In one or more specific embodiments, the composition exhibits a 5 log reduction or greater in a concentration of Escherichia coli, when the composition is present in an aqueous solution having an antimicrobial material concentration of about 0.007 g/liter or greater and the aqueous solution is exposed to Escherichia coli in water at 23° C. after 90 minutes. In one or more embodiments, the composition exhibits a 5 log reduction or greater in a concentration of Escherichia coli, when the composition is combined with an aqueous solution having an antimicrobial material concentration of about 0.07 g/liter or greater and the aqueous solution is exposed to Escherichia coli in water at 23° C. after 1 minute. The composition of one or more embodiments exhibits such log reductions of bacteria under JIS Z 2801 (2000) testing conditions or under a Modified JIS Z 2801 (2000) Test for Bacteria, the Dry Test or the EPA Test. In one or more embodiments, the composition exhibits a 0.5 log reduction or greater (e.g., 1 log reduction or greater, or a 2 log reduction or greater) in a concentration of any one or more of Influenza viruses, Human Immunodeficiency Virus, and Murine Norovirus, under the Modified JIS Z 2801 for Viruses).

The composition may comprise cosmetic products, oral care products, personal care products, clothing care products, and home care products, as described herein. In some instances, the composition may comprise at least a portion of paints (e.g., for use in residences, hospitals, laboratories or schools), coatings for packaging (e.g., food and medicine packaging), textiles, orthodontic devices (e.g., dentures, bracers, filling, pallet expanders), wound care (e.g., bandages), anti-microbial sprays and biomedical devices (e.g., catheters, IV needles, orthopedics devices, surgical mask and other medical devices).

A third aspect of this disclosure pertains to a method of forming the antimicrobial materials described herein. In one or more embodiments, the method includes providing an inorganic substrate; and exchanging and infusing an antimicrobial agent into the inorganic substrate. In one or more embodiments, the antimicrobial agent is exchanged and infused into the inorganic substrate at a pressure of about 5 MPa or greater, 10 MPa or greater or 20 MPa or greater.

In one or more embodiments, exchanging and infusing the antimicrobial agent into the inorganic substrate includes forming flaws or irregularities in the inorganic substrate, and facilitating the penetration of the antimicrobial agent into the flaws or irregularities. In one or more embodiments, the flaws or irregularities are formed in the surface of the inorganic substrate and the antimicrobial agent penetrates into one or more interstitial spaces in the substrate. In one or more embodiments, exchanging and infusing the antimicrobial agent into the inorganic substrate includes penetrating an oxygen-containing inorganic substrate with hydrogen ions and replacing a portion of the oxygen with the antimicrobial agent. In some embodiments, the oxygen is replaced out of the substrate as —OH. Without being bound by theory, it is believed that hydronium ions (H₃O⁺) enters the inorganic substrate and disrupts the silica (SiO₂) present in the inorganic substrate such that Si—OH is formed. In some instances the —OH forms H₂O.

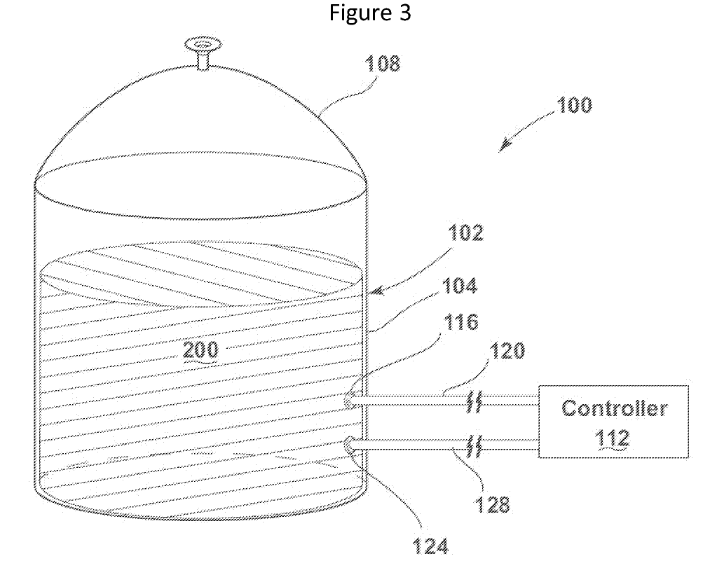

In one or more embodiments, exchanging and infusing the antimicrobial agent into the inorganic substrate may be performed according to the processes described in U.S. Provisional Patent Application No. 61/977,692, filed on Apr. 10, 2014, titled “Antimicrobial and Strengthened-Glass Articles Through Pressurized Ion Exchange.” As shown in FIG. 3, exchanging and infusing the antimicrobial agent into the inorganic substrate may be performed in a system 100 including a pressure vessel 102 having both a pressure vessel body 104 and a pressure vessel lid 108. The vessel 102 contains a bath 200. The bath 200 comprises a solvent and a plurality of ions dissolved within the solvent. In one embodiment, the pressure vessel 102 can include a pressure sensor 116 and a temperature sensor 124. Both sensors can be connected to a controller 112 though a pressure coupling 120 and a temperature coupling 128, respectively. The controller 112 is capable of independently varying the temperature and the pressure within the pressure vessel 102 and the bath 200.

The bath 200 can comprise various solvent compositions. The solvent is preferably a polar liquid while at ambient temperature and pressure. The choice of polar solvent is not limited to particular compositions. For example, the solvent can be a protic polar solvent such as water, methanol, ethanol, isopropanol, nitromethane, formic acid, acetic acid, ethylene glycol, 1,3-propanediol, glycerol, or any other protic polar solvent or combination of protic polar solvents. Similarly, the polar solvent can also be an aprotic polar solvent such as acetone, ethyl acetate, acetonitrile, dimethyl sulfoxide, tetrahydrofuran, dimethylformamide, or any other aprotic polar solvent or combination of aprotic polar solvents. Further, the solvent may be a combination of protic and aprotic solvents in variable proportions.

The ions of the bath 200 employed in system 100 can comprise a variety of ions from a variety of sources. The ions may be introduced to the bath 200 from dissolution of salts, acids, and other known methods of introducing ions to a liquid. One family of salts that can be dissolved in the bath 200 includes metal salts. These metal salts can include transition metal ions including, but not limited to, copper, silver, chromium, nickel, cobalt, erbium, and iron. Exemplary salts can include silver nitrate, silver fluoride, silver perchlorate, copper (I) chloride, copper (I) acetate, copper (II) chloride, copper (II) nitrate, copper (II) sulfate, and erbium nitrate. Another exemplary sub-family of metal salts includes salts which comprise group 1A alkali metal ions. Such group 1A metal ions can include lithium, sodium, potassium, rubidium, and cesium. Exemplary salts containing these ions can include potassium sulfate, potassium hydroxide, potassium thiosulfate, potassium thioacetate, potassium monobasic phosphate, potassium dibasic phosphate, potassium tribasic phosphate, lithium nitrate, lithium sulfate, lithium chloride, cesium nitrate, cesium sulfate, rubidium nitrate, rubidium chloride, and rubidium sulfate. Yet another illustrative sub-family of metal salts that may be used is group 2A metal salts. Such group 2A metal ions include beryllium, magnesium, calcium, strontium, and barium. Metal salts of the group 2A variety can be dissolved in the polar solvent of the bath 200 in a similar manner as the other metal salts.

Acids may also serve as an ion source for bath 200 of system 100. Acids typically donate positively charged hydrogen ions and a variety of negatively charged ions. Exemplary acids include hydrogen sulfate, hydrogen chloride, hydrogen nitrate, hydrogen phosphate, hydrogen carbonate, oxalic acid. In the case of water, the free hydrogen ion reacts with the water to form a hydronium, or H₃O⁺ ion, which can be used in an ion-exchange process employed in system 100.

Again referring to FIG. 3, the controller 112 employed in the system 100 is capable of sensing the temperature and the pressure of the pressure vessel 102 and the bath 200. Controller 112 is also capable of coordinating the pressure within the pressure vessel 102 independently of the vessel temperature. Controller 112 can also perform a variety of other functions including controlling the duration at which the pressure vessel 102 and the bath 200 are kept at specific temperatures and pressures.

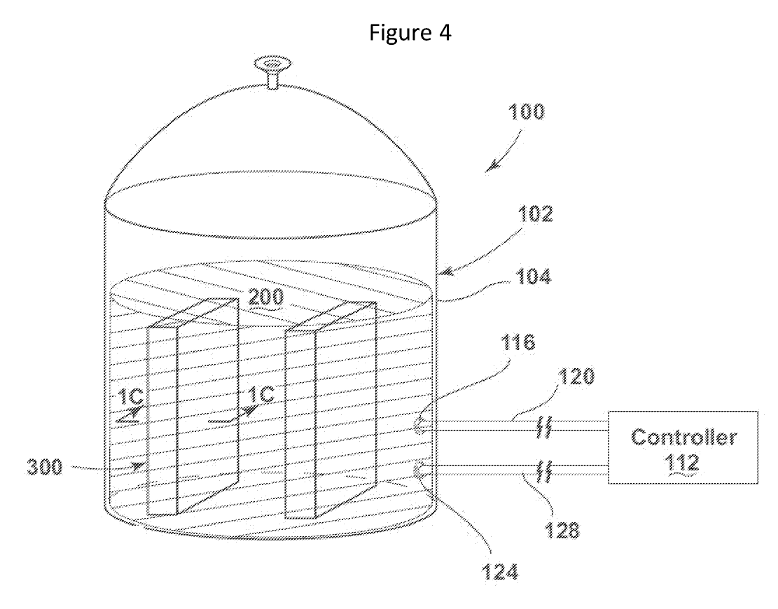

Referring to FIG. 4, the substrates 300 are placed within the pressure vessel body 104 of the pressure vessel 102 employed in system 100 such that the substrates 300 are submerged in the bath 200. In one embodiment, the pressure vessel 102 of the system 100 is capable of heating the bath 200 to temperatures between 50° C. and 1000° C. (e.g., from about 100° C. to about 375° C.), and more preferably to temperatures between 80° C. and 500° C. Pressure vessel 102 of the system 100 can be capable of attaining and sustaining pressures between about 0.1 MPa and about 100 MPa (e.g., from about 20 MPa to about 75 MPa). In some embodiments, vessel 102 can attain and sustain pressures between about 1.6 MPa and about 70 MPa. The pressure vessel 102 is capable of accepting substrates 300 of varying size and physical attributes. In one exemplary embodiment, the pressure vessel 102 is capable of accepting glass panels approximately 3.4 ft×4 ft. In another exemplary embodiment, the pressure vessel 102 is designed to accept glass panels approximately 6 ft×7 ft. In yet another embodiment, the pressure vessel 102 is capable of receiving multiple substrates 300 of different sizes and configurations. The design of the pressure vessel 102 is scalable in size and shape. Therefore, the pressure vessel 102 can be configured to fit various sizes and configurations of substrate 300 without appreciable loss of pressure or temperature in the bath 200 employed by system 100.

In one or more specific embodiments, exchanging and infusing the antimicrobial agent includes preparing a bath (e.g., bath 200) with a bath composition that comprises a polar solvent and a plurality of ions in a vessel (e.g., vessel 102); and submersing a substrate (e.g., substrate 300) in the bath. The method then includes steps of pressurizing the bath in the vessel to a predetermined pressure substantially above ambient pressure; and heating the bath in the vessel to a predetermined temperature and treating the substrate for a predetermined duration at the predetermined pressure and temperature such that a portion of the plurality of ions is exchanged and infused into the substrate. The predetermined duration, temperature and pressure can each be selected based at least in part on the substrate composition and the bath composition. In one embodiment, the predetermine temperature may include room temperature or hydrothermal subcritical or supercritical conditions in a pressure vessel. In some embodiments, the pressure is atmospheric and the temperature is room temperature. In one or more embodiments, the bath has a solid to solvent ratio is from about 0.05:1:00 to about 2:00-1:00.

In one or more embodiments, the method includes forming a compressive stress layer in the inorganic substrate before, after or during exchanging and infusing the inorganic substrate with an antimicrobial agent. In some embodiments, forming a compressive stress layer includes immersing the substrate in a molten bath including KNO₃, NaNO₃ or a combination thereof such that smaller alkali ions are exchanged for larger alkali ions. Other salts may be utilized in the bath. In one or more embodiments, forming the compressive stress layer includes preparing a bath in the pressure vessel that includes KNO₃, NaNO₃ or a combination thereof such that smaller alkali ions are exchanged for larger alkali ions. In some instances, the larger alkali ions may be exchanged into the substrate simultaneously with the exchange and infusion of the antimicrobial agent.

### EXAMPLES

Various embodiments will be further clarified by the following examples.

### Example 1

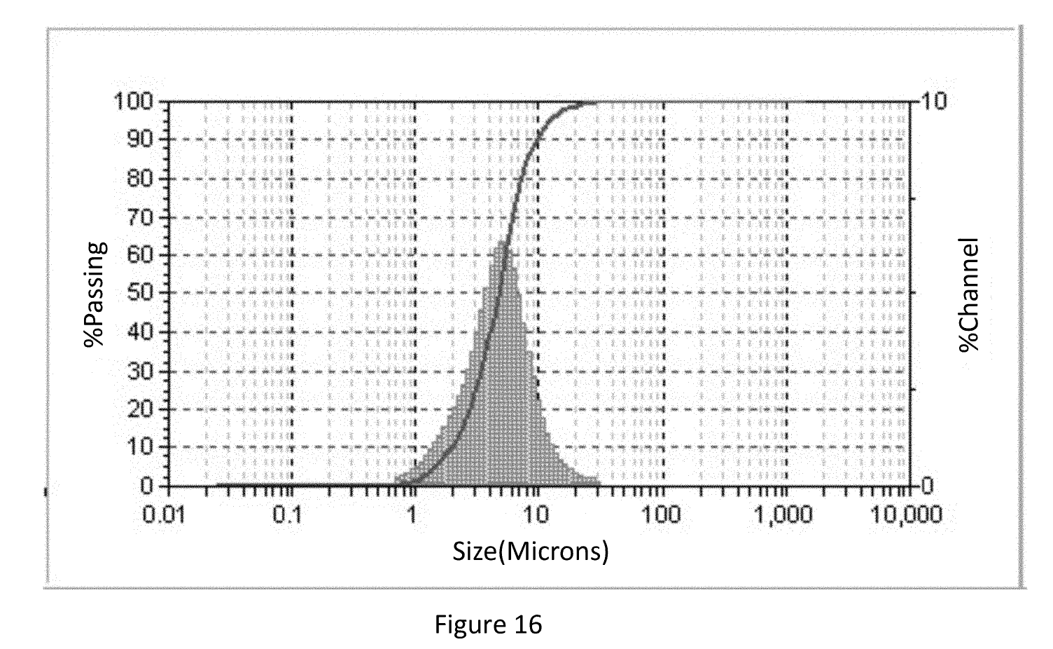

Example 1 was prepared by forming particulate inorganic substrates from an aluminosilicate glass having a nominal composition including about 58 mol % SiO₂, about 17 mol % Al₂O₃, about 17 mol % Na₂O, about 3 mol % MgO, and about 6.5 mol % P₂O₅. The particles were formed by jet-milling about 200 ml of the aluminosilicate glass to provide particles having a cross-sectional dimension in the range from about 1 micrometers (μm) to about 12 micrometers (μm), with an average longest cross-sectional dimension (D50) of about 5 micrometers (μm) (i.e., Dmin=1.93, D50=4.67, Dmax=12.19), as shown in FIG. 16 and below in Table 1.

TABLE 1
Cross-sectional dimensions of the particles of Example 1.

| % Tile | Size (μm) |
|---|---|
| 10.00 | 1.927 |
| 20.00 | 2.731 |
| 30.00 | 3.42 |
| 40.00 | 4.05 |
| 50.00 | 4.66 |
| 60.00 | 5.35 |
| 70.00 | 6.16 |
| 80.00 | 7.30 |
| 90.00 | 9.47 |
| 95.00 | 12.19 |

About 50 grams of the particles were introduced in a pressure vessel (having a volume of 1 liter) that included a 50 ml-bath of 1:1 silver nitrate to water, 100 g of bulk water solution. The pressure vessel was pressurized to 25 MPa and the temperature was set to 200° C. The duration of the exchange and infusion was 4 hours. After the 4 hour-duration, the particles and the bath solution were separated (decanted) and dried at room temperature. The particles were washed three times in deionized water to remove excess silver nitrate and then dried at 40° C. overnight.

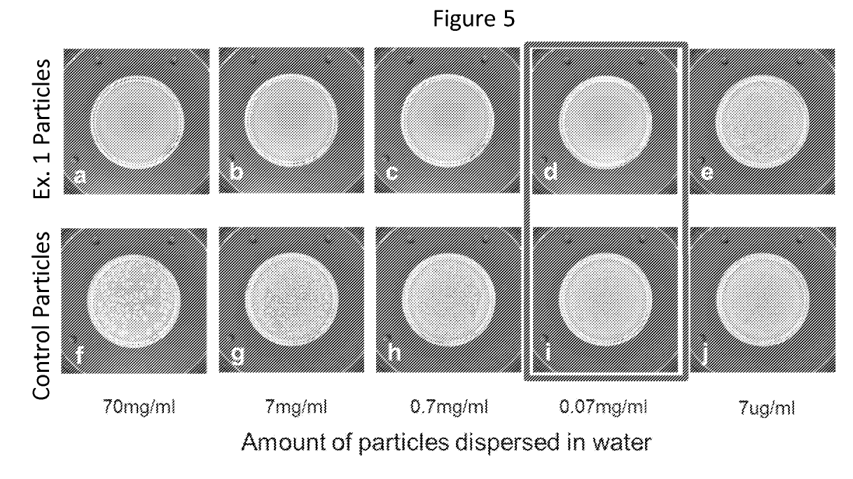

The particles were placed in water at a concentration of 70 mg particles/ml of water, at a temperature of 23° C. Escherichia coli from slant culture was re-suspended in water at a concentration of 8 log 10 CFU/ml and added to the particle solution at final concentration of 7 log 10 CFU/ml. After a given exposure time of 1 minute, 30 minutes and 90 minutes, at 23° C., the Escherichia coli bacteria and particles in solution were filtered through a 20 μm membrane filter. The Ag ions were neutralized by immediate addition of 10 ml of Letheen Broth (LB). Enumeration of live bacteria was assessed by colonies Plate counting. Bacteria (100 ul) in contact with the particles were platted on Nutrient Agar plate without further dilution, as shown in FIGS. 5a, 5b, 5c, 5d and 5e). Control particles, which are not exchanged and infused with the antimicrobial agent were diluted in LB (at a concentration of 1:100) and platted (100 ul) on Nutrient Agar plate, as shown in FIGS. 5f, 5g, 5h, 5i and 5j).

All of the plates were incubated at 37° C. for 24 hours and colonies were count to estimate the kill rate (Log Reduction=Log 10a−Log 10b or % Reduction=(a−b)/a*100, where “a” is number of organisms surviving in contact with control particles and “b” is number of organisms surviving in contact with the particles of Example 1.

As shown in FIG. 5, while Escherichia coli survived very well after being in contact with control particles, the particles of Example 1 killed at the same rate as chlorine in water and a complete inactivation of Escherichia coli in water at 23° C. by exposure to 0.07 mg/mL of dispersed particles and water was observed after only 1 minute (as shown in FIGS. 5d and 5i).

Different concentrations of the particles of Example 1 and water were prepared, as shown in Table 1A. The amount of leached silver (or leachables) of each solution was measured by Inductively coupled plasma mass spectrometry (ICP-MS). As shown in Table 1A, the concentration of leached silver was below levels of silver allowed in drinking water (e.g., about 0.1 ppm).

TABLE 1A
Solutions of the particles of Example 1 and the measured amount of
silver leached from the particles.

| Sample Name | | Ag (ppm) |
|---|---|---|
| Control Particles (not exchanged and infused | | 0.027 |
| with silver and not in solution) | | |
| Example 1 particles - concentration | 70 g/L | 0.687 |
| of particles in water | 7 g/L | 0.299 |
| | 0.7 g/L | 0.225 |
| | 0.07 g/L | 0.059 |
| | 0.007 g/L | 0.038 |

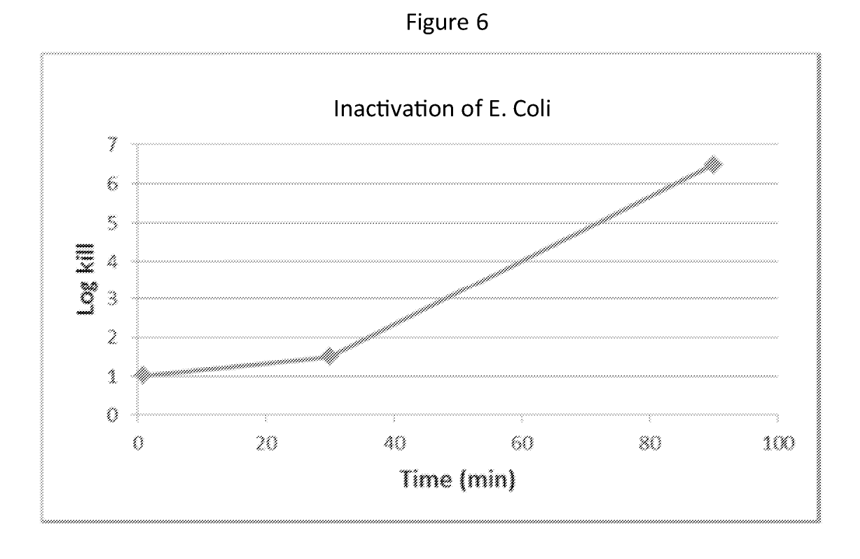

FIG. 6 is a graph illustrating the inactivation of Escherichia coli as function of time by a solution having a concentration of the particles of Example 1 of about 0.007 g/L. As shown in FIG. 6, the solution exhibited a greater than about 99.999% reduction of Escherichia coli in about 90 minutes.

### Example 2

Example 2 was prepared by providing the same particulate inorganic substrates as used in Example 1 and then infusing and exchanging silver into the particles in the same pressure vessel using a superheated solution of 100 g AgNO₃ in 100 mL of water at 200° C. and 25 MPa for 4 hours.

Table 2 shows the compositional analysis of the particles of Example 2 before and after being exchanged and infused with the antimicrobial agent. As shown in Table 2, alkali are still present in the particles, indicating infusion in addition to an exchange of the antimicrobial agent with alkali. Specifically, the amount of silver present in the particles increases from zero to about 7.03 mol %; however, the total amount of alkali was reduced by only 2.67 mol %. The amount of potassium did not change and the amount of sodium decreased only by 2.67 mol %, indicating some silver was exchanged with sodium. Without being bound by theory, it is believed that the amount of oxygen decreased after the exchange and infusion of silver and the amount of Si remained constant, though the relative amount of Si changed due to changes in the amount of oxygen and silver after the exchange and infusion of the silver.

TABLE 2
Compositional analysis of the particles of Example 2
before and after the exchange and infusion of silver.

| | Before infusion and | After infusion and |
|---|---|---|
| Units | exchange | exchange |
| mole % K | 0.01 | 0.01 |
| mole % Na | 9.32 | 6.65 |
| mole % Al | 9.30 | 9.36 |
| mole % Mg | 0.78 | 0.79 |
| mole % P | 3.70 | 3.73 |
| mole % Si | 16.08 | 27.57 |
| mole % Ag | 0.00 | 7.03 |
| mole % O | 60.81 | 44.87 |
| Total mole % | 100.00 | 100.00 |

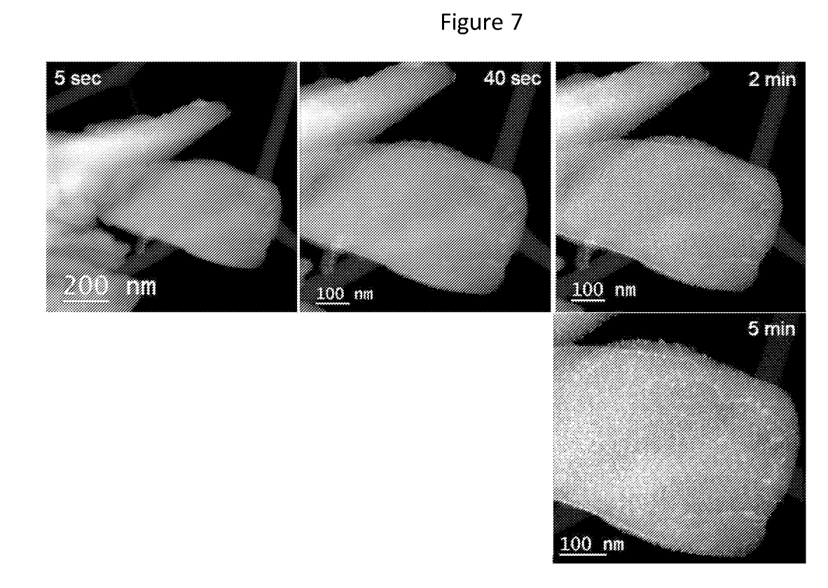

FIG. 7 shows HAADF images indicating the presence of silver as nanoparticles on the surface of the antimicrobial material. The images are shown after 5 seconds, after 40 seconds, after 2 minutes and after 5 minutes of exposure to an electron beam, indicating the reduction of the silver by the electron beam, over time.

### Example 3

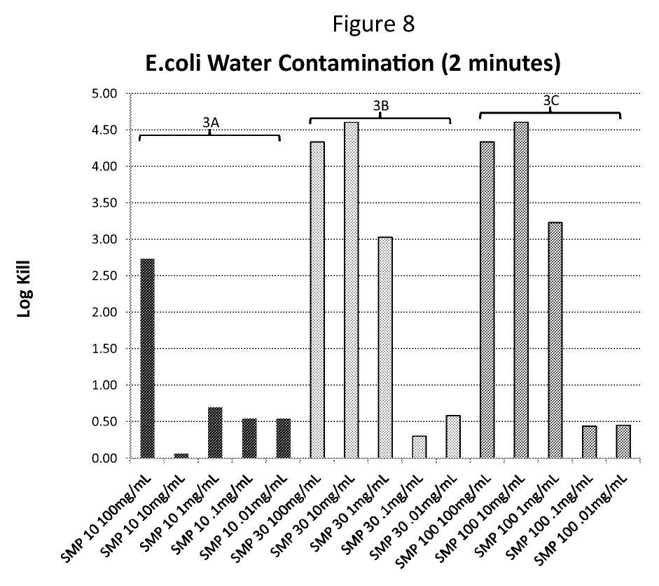

The concentration dependence of the concentration of AgNO₃ in the bath used to form the particles of one or more embodiments of this disclosure and the kill rate on E-coli bacteria was evaluated. Examples 3A-3B utilized the same particulate inorganic substrates that were used Examples 1 and 2. Example 3A was formed using a bath having a 10% concentration of AgNO₃ in water in a pressure vessel at a temperature of 150° C. and pressure of 25 MPa and Example 3B was formed using a bath having a 30% concentration of AgNO₃ in water in a pressure vessel at a temperature of 200° C. and pressure of 25 MPa, respectively for 4 hours. Example 3C was formed using a bath having a 100% concentration of AgNO₃ in water (which corresponds to 100 g of AgNO₃ in 100 ml of water) in a pressure vessel at a temperature of 200° C. and pressure of 25 MPa for 4 hours. The particles of Examples 3A-3C were then added to water at different concentrations, as shown in FIG. 8, to which Escherichia coli was added in the same manner as Example 1 for an exposure time of 2 minutes. The log kill of Escherichia coli was measured in the same manner as Example 1.

As shown in FIG. 8, particles formed using low concentrations of AgNO₃ in a pressure vessel and thus including low concentrations of silver exhibited a log reduction of 3 or greater. Specifically, the use of a 30% AgNO₃ solution to infuse and exchange silver into the particulate inorganic substrates provided comparable antimicrobial activity as the use of a 100% AgNO₃ solution.

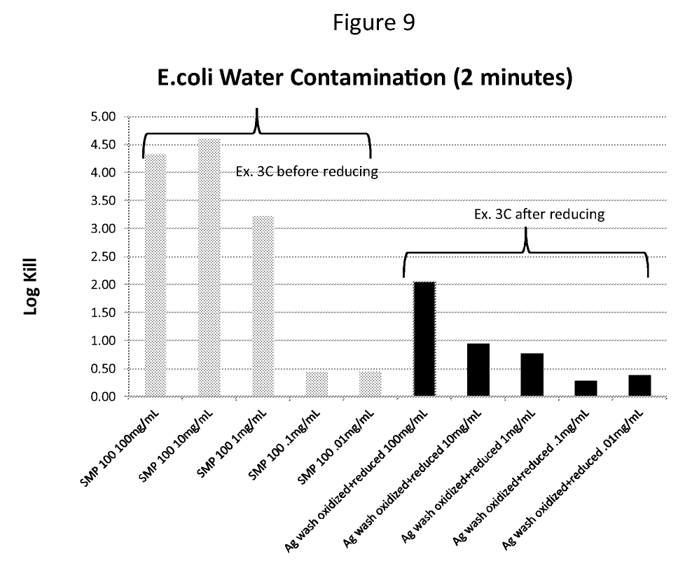

The kill rate of the particles of Example 3C was evaluated before and after reducing to Ag metal with hot glycerol and re-oxidized to Ag₂O with bleach. The reduced particles were not as effective in killing E-coli as shown in the FIG. 9. One explanation for the reduction in Log Kill rate is that the Ag was not efficiently converted back to the oxide with the bleach treatment.

The particles of Example 3C (without reducing and re-oxidation) were combined with two different carriers. The carriers included a white, semigloss paint, supplied by Behr Process Corporation under the trademark Behr® with no surfactant and the same paint with 1 wt % of a sodium oleate surfactant. The particles had a loading of 10% of the mass of the carrier . . . . Comparative Example 3D included a known antimicrobial glass substrate that is only exchanged with silver (and not infused with silver) using a 7 wt % aqueous solution of AgNO₃. Specifically, Comparative Example 3E included known antimicrobial glass particles supplied by Mo-Sci Health Care at 10% loading and Comparative Example 3F included an antimicrobial material supplied by Addmaster (UK) Limited, under the tradename Biomaster, at a 10% loading. Comparative Examples 3D, 3E and 3F were combined with the same carriers and same loading as Example 3C.

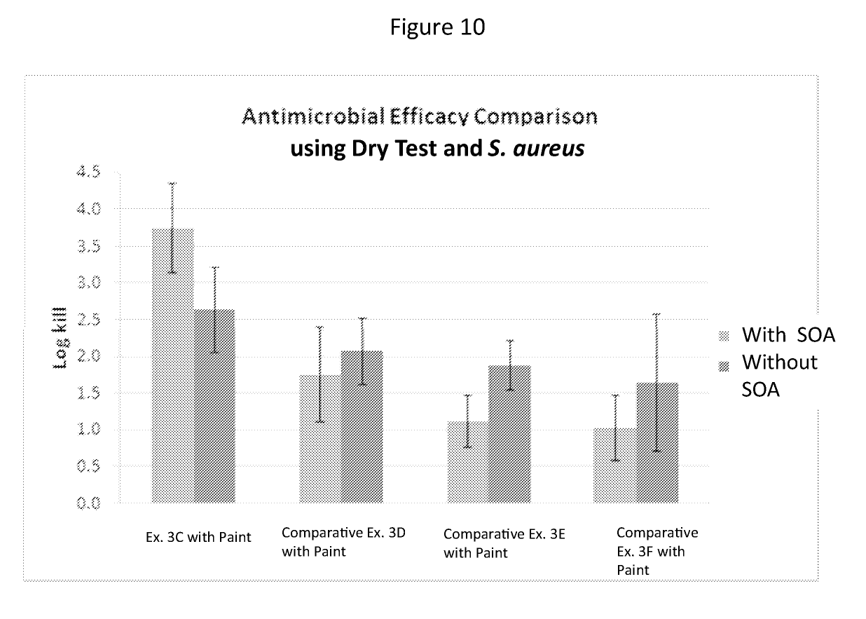

Example 3C and Comparative Examples 3D-3F were evaluated under the Dry Test, described herein, using S. aureus. The results are shown in FIG. 10 for Example 3C and Comparative Examples 3D-3F combined with paint (with and without a surfactant). It is noted that the bars shown in FIG. 10 are t-95% confidence interval bars. As shown in FIG. 10, Example 3C exhibited increased antimicrobial activity over Comparative Examples 3D-3F with and without the surfactant. As also shown in FIG. 10, each Comparative Example exhibited a reduction in antimicrobial efficacy, whereas Example 3C exhibited a significant increase in antimicrobial efficacy (i.e., from about a 2.6 log reduction to a 4 log reduction). Without being bound by theory, it is believed that the cations in the surfactant attracts moisture to the surface of the antimicrobial materials and draws the antimicrobial agent to the surface of the antimicrobial materials and possibly the painted surface. Typically, surfactants are utilized to provide stability to polymeric carriers; however, the data suggests that surfactant molecule migration causes or enhances water sensitivity of the polymer.

### Example 4

Example 4A included the same substrate as used in Example 1 and Example 4B included a substrate having an aluminosilicate glass composition including about 60 mol % SiO₂, 15 mol % Al₂O₃, 16.5 mol % Na₂O, 3 mol % MgO, 5.2 mol % P₂O₅ and about 0.1 mol % SnO₂. Examples 4A and 4B were formed into particles using the same process and having the same dimensions, as shown in Example 1. The particles were introduced in the same pressure vessel as used in Example 1, that included a 50 ml-bath of 1:1 silver nitrate to water, 100 g of bulk water solution. The pressure vessel was pressurized 45 MPa and the temperature was set to 330° C. The duration of the exchange and infusion was 4 hours. After the 4 hour-duration, the particles and the bath solution were separated (decanted) and dried at room temperature. The particles were washed three times in deionized water to remove excess silver nitrate and then dried at 40° C. overnight.

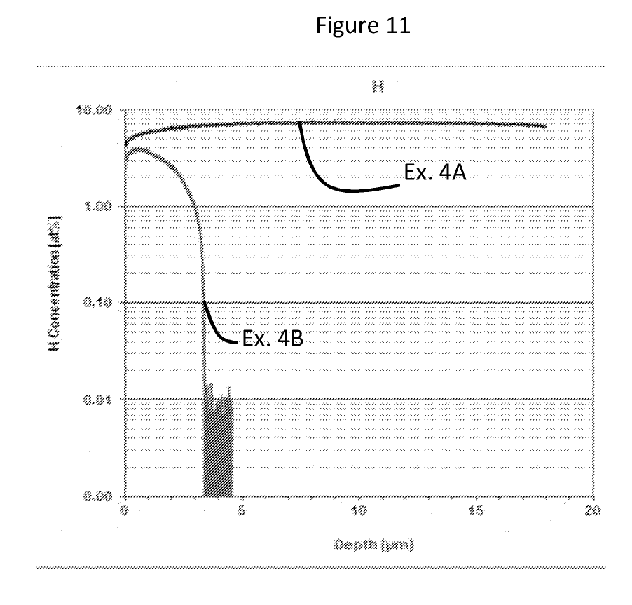

SIMS was used to evaluate the particles. As shown in FIG. 11, the spectra show hydrogen is present in the particles to a depth of about 20 micrometers (μm) for Example 4A and a depth of about 5 micrometers (μm) for Example 4B.

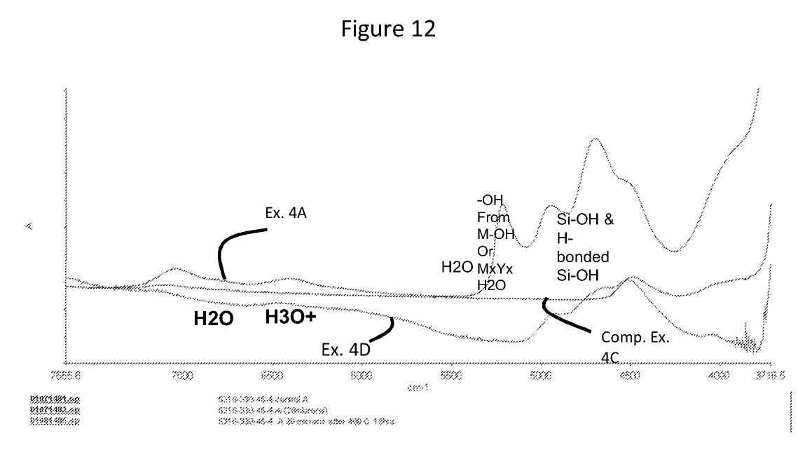

A control sample (Comparative Example 4C) of the substrate used for Example 4A (without being exchanged and infused with the antimicrobial agent), a sample of Example 4A as formed and without any additional post-processing, and Example 4D, which is a sample of Example 4A that has been heated at 400° C. for 18 hours, were evaluated using FTIR. As shown in FIG. 12, the spectra show the presence of Si—OH and H₂O due to the diffusion of H₃O⁺ into the substrate during the exchange and infusion of the antimicrobial agent.

### Example 5

Example 5 included a soda lime silicate glass substrate that was formed into particles using the same process and having the same dimensions, as shown in Example 1. The particles were introduced in the same pressure vessel as used in Example 1, that included a 50 ml-bath of 1:1 silver nitrate to water, 100 g of bulk water solution. The pressure vessel was pressurized to 45 MPa and the temperature was set to 330° C. The duration of the exchange and infusion was 4 hours. After the 4 hour-duration, the particles and the bath solution were separated (decanted) and dried at room temperature. The particles were washed three times in deionized water to remove excess silver nitrate and then dried at 40° C. overnight.

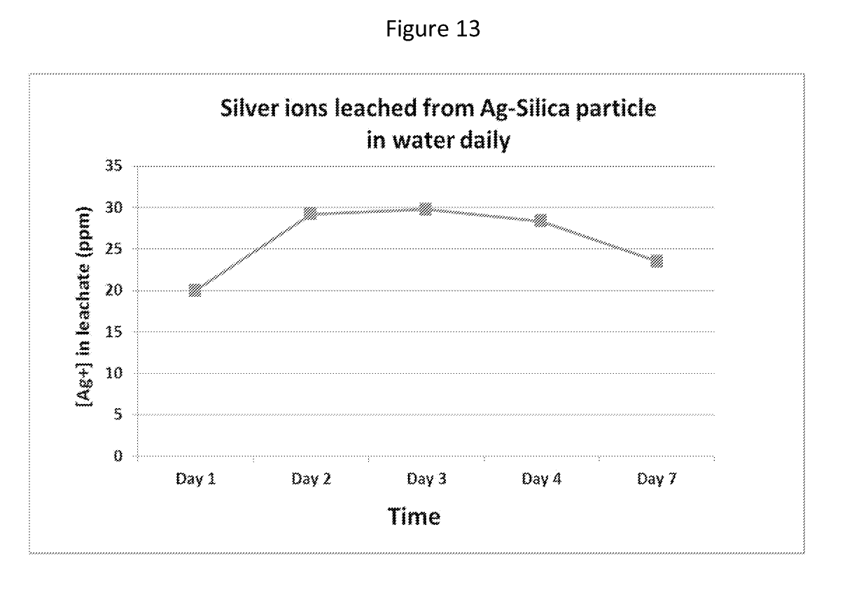

The particles were mixed with water at a concentration of 10 mg particles/ml of water. An aliquot of the mixture was evaluated to determine the concentration (in ppm) of silver ions leached into the water on the first day after the mixture was prepared. The particles were then filtered out of the mixture, and added to fresh water at the same concentration. An aliquot of the mixture was evaluated to determine the silver ion leachate concentration on the second day, and then again on the third day, the fourth day and on the seventh day, using the same procedure in which the particles are filtered out of the mixture and added to fresh water after each evaluation. The concentration of the silver ions in the leachate is plotted as a function of the day collected, in the graph shown in FIG. 13. As shown in FIG. 13, the particles release silver ions at a consistent rate, without a significant decrease of concentration.

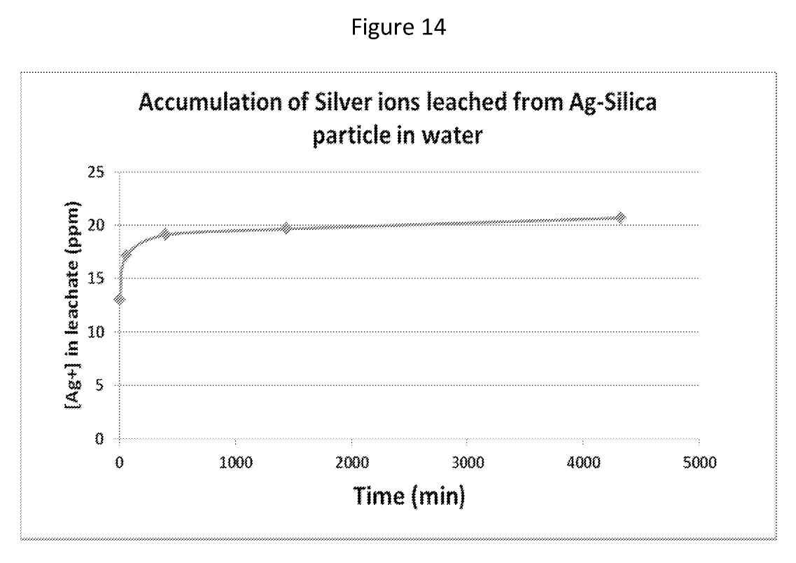

Fresh particles prepared in Example 5 were mixed with water at a concentration of 10 mg particles/ml of water. An aliquot of the mixture was evaluated immediately after preparation to determine the concentration (in ppm) of silver ions leached into the water. The same mixture was evaluated after various time periods to determine the leach rate over time. (i.e., the particles were not filtered and mixed with fresh water). The concentration of silver ions was plotted as a function of time (minutes), in FIG. 14. As shown in FIG. 14, the silver leachate concentration increases with time and then reaches a steady state or substantially constant concentration.

### Example 6

Example 6 included the same substrate as used in Example 5, which was formed into particles using the same process and having the same dimensions, as shown in Example 1. The particles were introduced in the same pressure vessel as used in Example 1, that included a bath of a solution including 20 g silver nitrate/100 g water. The pressure vessel was pressurized 25 MPa and the temperature was set to 200° C. The duration of the exchange and infusion was 4 hours. After the 4 hour-duration, the particles and the bath solution were separated (decanted) and dried at room temperature. The particles were washed three times in deionized water to remove excess silver nitrate and then dried at 40° C. overnight.

The particles were combined with water at a particle loading of 125 g to provide different concentrations of particles in the mixture. Example 6A had a concentration of 100 mg/ml, Example 6B had a concentration of 10 mg/ml, Example 6C had a concentration of 1 mg/ml and Example 6D had a concentration of 0.1 mg/ml. Escherichia coli was added to each of Examples 6A-6D in the same manner as Example 1. The log kill of Escherichia coli was measured in the same manner as Example 1. Each of Examples 6A-6D exhibited a log reduction in Escherichia coli of greater than 6.5, indicating that regardless of the dilution of the particles, the same high kill rate was observed.

Examples 6E-6M utilized the substrates used in Example 1 to form the particles. Examples 6E-6M used the same process to infuse silver into the particles as Example 6A-6D but the bath included different concentrations of silver nitrate. Examples 6E utilized a bath including 10 g silver nitrate/100 ml of water. Examples 6F-6G used a bath including 20 g silver nitrate/100 ml of water. Examples 6H-6M used a bath including 30 g silver nitrate/100 ml of water.

Examples 6E-6M were combined with water at different particle loadings to provide various concentrations of particles in the mixture, as shown in Table 3. Escherichia coli was added to each of Examples 6E-6N in the same manner as Example 1. The log kill of Escherichia coli was measured in the same manner as Example 1. The log reduction in Escherichia coli for each of Examples 6E-6N is shown in Table 3.

TABLE 3
Examples 6E-6N.

| | | | Bath | |
|---|---|---|---|---|
| | | Concentration | concentration | |
| | Loading | of mixture | (g AgNO₃/ml | |
| Example | (g) | (mg/ml) | water) | Log Reduction |
| 6E | 125 g | 100 | 10 g/100 ml | 6.75 or greater |
| 6F | 125 g | 100 | 20 g/100 ml | 6.75 or greater |
| 6G | 125 g | 10 | 20 g/100 ml | 6.75 or greater |
| 6H | 125 g | 100 | 30 g/100 ml | 6.75 or greater |
| 6I | 125 g | 10 | 30 g/100 ml | 6.75 or greater |
| 6J | 125 g | 1 | 30 g/100 ml | 5.75 or greater |
| 6K | 150 g | 100 | 30 g/100 ml | 6.75 or greater |
| 6L | 150 g | 10 | 30 g/100 ml | 6.75 or greater |
| 6M | 150 g | 1 | 30 g/100 ml | 6.75 or greater |

### Example 7

Example 7 included a soda lime silicate glass substrate that was formed into particles having an average longest cross-sectional dimension of 0.3 μm (Ex. 7A) and 5 μm (Ex. 7B) using a similar process to the process outlined in Example 1. The particles of Exs. 7A and 7B were introduced in the same pressure vessel as used in Example 1, along with an aqueous silver nitrate solution. In particular, the solution contained 30 g AgNO₃ and 100 g of water. The pressure vessel was pressurized to 25 MPa and the temperature was set to 175° C. for the Ex. 7A samples and 200° C. for the Ex. 7B samples. After the step for introducing the Ag ions within the pressure vessel was completed, the particles and the bath solution were separated (decanted) and dried at room temperature. The particles were washed three times in deionized water to remove excess silver nitrate and then dried at 40° C. overnight.

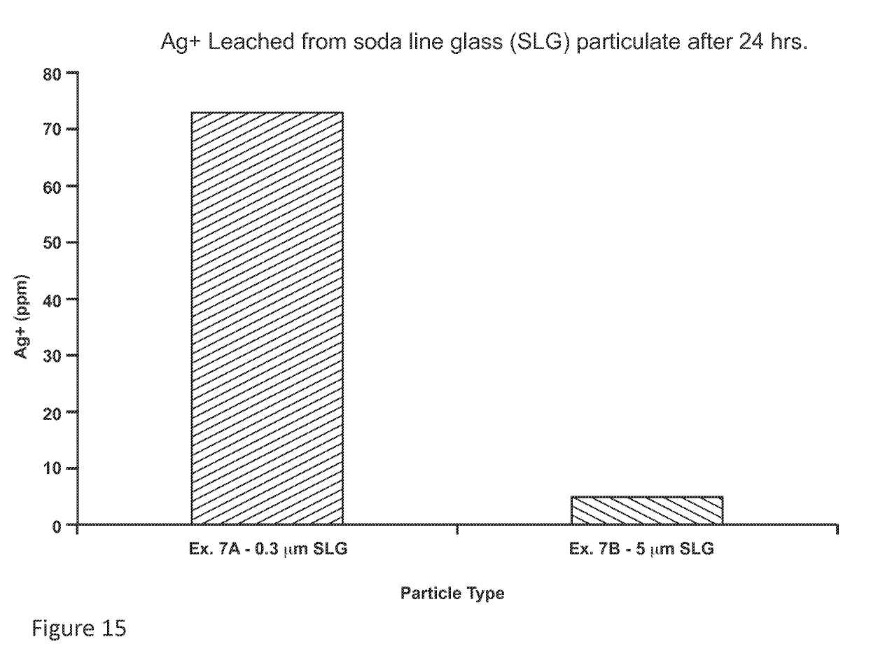

The glass particles of the Ex. 7A and 7B samples infused with Ag ions were mixed with water at a concentration of 10 mg particles/ml of water. An aliquot of the mixture was evaluated to determine the concentration (in ppm) of silver ions leached into the water at the end of the first day after the mixture was prepared (i.e., after a 24-hour immersion duration). The concentration of the silver ions in the leachate is plotted for Ex. 7A and 7B in the chart shown in FIG. 15. As shown in FIG. 15, the significantly smaller Ex. 7A particles released silver ions at about 73 ppm and the larger Ex. 7B particles released silver ions at about 5 ppm. Without being bound by theory, it is believed that the Ex. 7A particles released silver ions at a substantially higher leach rate than the Ex. 7B particles because the Ex. 7A particles possess a substantially larger surface area and the larger surface area contributes to higher levels of silver ion uptake during infusion in the pressure vessel.

It will be apparent to those skilled in the art that various modifications and variations can be made without departing from the spirit or scope of the invention.

What is claimed is:

1. An antimicrobial material comprising:
an inorganic substrate comprising alkali, the inorganic substrate comprising a surface portion surrounding an internal portion; and
an antimicrobial agent disposed on any one or more of the surface portion and the internal portion,
wherein at least a portion of the alkali is present on the surface portion.

2. An antimicrobial material comprising:
an inorganic substrate comprising a surface portion surrounding an internal portion; and
an infused antimicrobial agent disposed on any one or more of the surface portion and the internal portion.

3. The antimicrobial material of claim 2, further comprising exchanged antimicrobial agents, wherein the substrate comprises non-alkali components that are replaced with the antimicrobial agent.

4. The antimicrobial material of claim 2, wherein the inorganic substrate is substantially alkali-free.

5. An antimicrobial material comprising:
an inorganic substrate comprising anions and a surface portion surrounding an internal portion; and
an antimicrobial agent disposed on any one or more of the surface portion and the internal portion,
wherein at least at portion of the anions is exchanged for the antimicrobial agent.

6. The antimicrobial material of claim 5, wherein the anions comprise oxygen.

7. The antimicrobial material of claim 6, further comprising any one or more of Si—OH, H₂O and H₃O+ at a depth of about 1 micrometer or greater into the substrate.

8. The antimicrobial material of claim 5, further comprising leachables, wherein the leachables consist essentially of the antimicrobial agent.

9. The antimicrobial material of claim 8, wherein the leachables are released in the presence of moisture.

10. The antimicrobial material of claim 9, wherein the leachables are released at a rate of about 0.1 parts per million or less.

11. The antimicrobial material of claim 9, wherein the leachables are released at a rate from about 0.03 ppm to about 7 ppm.

12. The antimicrobial material of claim 9, wherein the leachables are released at a rate from about 5 ppm to about 80 ppm.

13. The antimicrobial material of claim 5, wherein the antimicrobial agent is present in an amount in the range from about 1% by weight to about 40% by weight.

14. The antimicrobial material of claim 13, wherein the concentration of the antimicrobial agent is homogenous.

15. The antimicrobial material of claim 5, wherein the inorganic substrate comprises a sheet or a particle.

16. The antimicrobial material of claim 5, wherein the inorganic substrate comprises any one of an amorphous substrate and a crystalline substrate.

17. The antimicrobial material of claim 16, wherein the inorganic substrate comprises a soda lime silicate glass, an aluminosilicate glass, a borosilicate glass, and an aluminoborosilicate glass.

18. The antimicrobial material of claim 5, wherein the inorganic substrate comprises a compressive stress layer extending from the surface portion into the internal portion.

19. The antimicrobial material of claim 18, wherein the inorganic substrate comprises a particle having an average longest cross-sectional dimension in the range from about 1 nanometer (nm) to about 10 millimeter (mm).

20. The antimicrobial material of claim 19, wherein the average longest cross-sectional dimension comprises any one of the ranges from about 1 nanometer (nm) to about 1000 nanometers (nm), from about 1 micrometers (μm) to about 1000 micrometers (μm), and from about 1 millimeter (mm) to about 10 millimeter (mm).

21. The antimicrobial material of claim 19, wherein the average longest cross-sectional dimension comprises a range from about 0.3 μm to about 5 μm.

22. The antimicrobial material of claim 19, wherein the particle comprises a regular geometry or an irregular geometry.

23. The antimicrobial material of claim 5,
wherein the antimicrobial agent comprises a silver-containing agent, and
wherein the antimicrobial material comprises a leachability of silver ions in the range from about 0.03 parts per million (ppm) to about 5 parts per million (ppm), when the antimicrobial material combined in an aqueous solution.

24. The antimicrobial material of claim 23, wherein the antimicrobial material exhibits a 5 log reduction or greater in a concentration of Escherichia coli, when the antimicrobial material is present in an aqueous solution having an antimicrobial material concentration of about 0.007 g/liter or greater and the aqueous solution is exposed to Escherichia coli in water at 23° C. after 90 minutes.

25. The antimicrobial material of claim 23, wherein the antimicrobial material exhibits a 5 log reduction or greater in a concentration of Escherichia coli, when the antimicrobial agent is combined with an aqueous solution having an antimicrobial material concentration of about 0.07 g/liter or greater and the aqueous solution is exposed to Escherichia coli in water at 23° C. after 1 minute.

26. (canceled)

27. The antimicrobial material of claim 5, wherein the antimicrobial material comprises a portion of a cosmetic product, an oral care product, a personal care product, a clothing care product, a home care product, an auto care product, a touch-sensitive display screen or cover plate for an electronic device, a non-touch-sensitive component of an electronic device, a surface of a household appliance, a surface of medical equipment, a biological or medical packaging vessel, or a surface of a vehicle component.

28. A composition comprising:
a carrier; and
an inorganic substrate comprising a surface portion surrounding an internal portion; and
an antimicrobial agent disposed on any one or more of the surface portion and the internal portion,
wherein the composition comprises one of:
the inorganic substrate comprises alkali and at least a portion of the alkali remains on the surface portion of the inorganic substrate,
the antimicrobial agent is infused and exchanged into the any one or more of the surface portion and the internal portion off the substrate, and
the inorganic substrate comprises anions and at least at portion of the anions is exchanged for the antimicrobial agent.

29. The composition of claim 28, wherein the carrier comprises any one of a surfactant and a polymer.

30. The composition of claim 28, further exhibiting a 5 log reduction or greater in a concentration of Escherichia coli, when the composition is exposed to Escherichia coli in water at 23° C. after 90 minutes.

31. The composition of claim 28, further comprising any one of cosmetics, oral care products, personal care products, clothing care products, and home care products.

32. A method of forming an antimicrobial material comprising
providing an inorganic substrate; and
exchanging and infusing an antimicrobial agent into the inorganic substrate at a pressure of about 5 MPa or greater
to provide an antimicrobial material.

33. The method of claim 32, wherein the inorganic substrate comprises alkali and a portion of the alkali remains on a surface of the substrate.

34. The method of claim 32, wherein the inorganic substrate comprises non-alkali components that are exchanged for the antimicrobial agent.

35. The method of claim 32, further comprising combining the antimicrobial material with a carrier.

36. The method of claim 35, wherein the carrier comprises any one or more of a surfactant and a polymer.

37. The composition of claim 28, wherein the composition comprises a portion of cosmetic products, oral care products, personal care products, clothing care products, home care products, paints, coatings for packaging, textiles, orthodontic devices, wound care products, anti-microbial sprays, and biomedical devices.
